(19) United States
(12) Patent Application Publication
(10) Pub. No.: US 2025/0386019 A1
(43) Pub. Date: Dec. 18, 2025

(54) SPATIAL GEOMETRIC PARTITION MODE

(71) Applicant: InterDigital CE Patent Holdings, SAS, Paris (FR)

(72) Inventors: Ya Chen, Rennes (CA); Karam Naser, Mouazé (FR); Antoine Robert, Mézières sur Couesnon (FR); Kevin Reuzé, Rennes (FR)

(73) Assignee: InterDigital CE Patent Holdings, SAS, Paris (FR)

(21) Appl. No.: 18/878,269

(22) PCT Filed: Jul. 3, 2023
(86) PCT No.: PCT/EP2023/068156

§ 371 Date: Dec. 23, 2024

(30) Foreign Application Priority Data
Jul. 5, 2022 (EP) 22306007.0

(51) Int. Cl. H04N 19/119; H04N 19/11; H04N 19/159; H04N 19/176; H04N 19/593

(52) U.S. Cl. CPC H04N 19/119; H04N 19/11; H04N 19/159; H04N 19/176; H04N 19/593

(57) ABSTRACT

Systems, methods, and instrumentalities are disclosed associated with spatial geometric partition mode (SGPM). In examples, a device (e.g., a video encoder and/or a video decoder) may derive a first candidate intra prediction mode (IPM) based on a first template of a coding block. The device may derive a second candidate IPM based on a second template of the coding block. The device may process the coding block based on the first candidate IPM and the second candidate IPM.

### CROSS REFERENCE TO RELATED APPLICATIONS

This application claims the benefit of European Provisional Patent Application No. 22306007.0, filed Jul. 5, 2022, the contents of which are hereby incorporated by reference herein.

### BACKGROUND

Video coding systems can be used to compress digital video signals, e.g., to reduce the storage and/or transmission bandwidth needed for such signals. Video coding systems can include, for example, block-based, wavelet-based, and/or object-based systems.

### SUMMARY

Systems, methods, and instrumentalities are disclosed associated with spatial geometric partition mode (SGPM). In examples, a video decoding device may derive a first candidate intra prediction mode (IPM) based on a first template of a coding block. The device may derive a second candidate IPM based on a second template of the coding block. The device may decode the coding block based on the first candidate IPM and the second candidate IPM. The second template may be different from the first template.

The device may add the first candidate IPM and the second candidate IPM to an IPM candidate list associated with the coding block, and the coding block may be decoded based on the IPM candidate list.

The device may select a third candidate IPM based on a partition mode of the coding block. The device may add the first candidate IPM, the second candidate IPM, and the third candidate IPM to an IPM candidate list associated with the coding block. The coding block may be decoded based on the IPM candidate list.

The coding block may include a first partition and a second partition. The device may generate an IPM candidate list associated with the coding block based on the first candidate IPM and the second candidate IPM. The device may determine a first prediction mode for the first partition and a second prediction mode for the second partition based on a spatial geometric partition mode (SGPM) index and the IPM candidate list.

The device may determine that an SGPM is used for the coding block. Based on determining that the SGPM is used for the coding block, the device may obtain the first template and the second template of the coding block for IPM derivation. The second template may be different from the first template.

The device may determine that an SGPM is used for the coding block. Based on determining that the SGPM is used for the coding block, the device may obtain the first template and the second template of the coding block for IPM derivation. The device may rank candidates in an SGPM candidate list associated with the coding block based on a third template of the coding block. The third template of the coding block may include the first and the second template.

The device may determine the first and second templates of the coding block based on a partition mode associated with the coding block.

The coding block may include a first partition and a second partition. The device may determine the first template of the coding block based on the first partition. The device may decode the first partition of the coding block based at least on the first candidate IPM derived based on the first template. The device may determine the second template of the coding block based on the second partition. The device may decode the second partition of the coding block based at least on the second candidate IPM derived based on the second template.

The device may obtain a left template of the coding block as the first template. The device may obtain a top template of the coding block as the second template. The device may obtain a left template of the coding block having a width of 1 as the first template. The device may obtain a top template of the coding block having a height of 1 as the second template.

When deriving the first candidate IPM based on the first template, the device may obtain most probable modes (MPMs) associated with the coding block. The device may determine predictions of the first template that correspond to the MPMs. The device may select, from the MPMs, the first candidate IPM based on comparing the first template to the predictions that correspond to the most probable modes.

Systems, methods, and instrumentalities are disclosed associated with spatial geometric partition mode (SGPM). In examples, a video encoding device may derive a first candidate intra prediction mode (IPM) based on a first template of a coding block. The device may derive a second candidate IPM based on a second template of the coding block. The device may encode the coding block based on the first candidate IPM and the second candidate IPM.

The device may add the first candidate IPM and the second candidate IPM to an IPM candidate list associated with the coding block, and the coding block may be encoded based on the IPM candidate list.

The device may select a third candidate IPM based on a partition mode of the coding block. The device may add the first candidate IPM, the second candidate IPM, and the third candidate IPM to an IPM candidate list associated with the coding block. The coding block may be encoded based on the IPM candidate list.

The coding block may include a first partition and a second partition. The device may determine a first prediction mode for the first partition and a second prediction mode for the second partition. The device may generate an IPM candidate list associated with the coding block based on the first candidate IPM and the second candidate IPM. The device may determine a special geometric partition mode (SGPM) index based on the first prediction mode and the second prediction mode. The device may include the index in the IPM candidate list. The device may determine that an SGPM is used for the coding block. Based on determining that the SGPM is used for the coding block, the device may obtain the first template and the second template of the coding block for IPM derivation. The second template may be different from the first template.

The device may determine that an SGPM is used for the coding block. Based on determining that the SGPM is used for the coding block, the device may obtain the first template and the second template of the coding block for IPM derivation. The device may obtain a third template of the coding block that comprises the first and the second template. The device may rank candidates in an SGPM candidate list associated with the coding block based on the third template of the coding block. The device may determine an SGPM index based on the ranked candidates.

The device may determine the first and second templates of the coding block based on a partition mode associated with the coding block.

The coding block may include a first partition and a second partition. The device may determine the first template of the coding block based on the first partition. The device may encode the first partition of the coding block based at least on the first candidate IPM derived based on the first template. The device may determine the second template of the coding block based on the second partition. The device may encode the second partition of the coding block based at least on the second candidate IPM derived based on the second template.

When deriving the first candidate IPM based on the first template further comprises, the device may obtain most probable modes (MPMs) associated with the coding block. The device may determine predictions of the first template that correspond to the MPMs. The device may select, from the MPMs, the first candidate IPM based on comparing the first template to the predictions that correspond to the most probable modes.

The device may select a third candidate IPM based on a partition mode of the coding block. The device may rank combinations of the first candidate IPM, the second candidate IPM, and/or the third candidate IPM in ascending order based on their Sum of Absolute Differences (SAD) between a prediction of the coding block and a reconstruction of the coding block.

Systems, methods, and instrumentalities are disclosed associated with spatial geometric partition mode (SGPM). In examples, a device may obtain characteristics associated with a current block. Based on one or more of the characteristics, an intra prediction mode candidate list size may be determined for SGPM associated with the current block. An intra prediction mode candidate list may be obtained for the current block based on the determined intra prediction mode candidate list size. In examples, an order may be determined for intra prediction mode candidate types based on the characteristics. The intra prediction mode candidate list may be obtained based on the determined order.

In examples, a device may obtain characteristics associated with a current block. Based on one or more of the characteristics, a partition mode candidate list size may be determined for SGPM associated with the current block may be determined. A partition mode candidate list may be obtained for the current block based on the determined partition mode candidate list size. In examples, a selection may be determined for partition mode candidates based on the characteristics.

In examples, a device may obtain characteristics associated with a current block. Based on one or more of the characteristics, a SGPM candidate list size associated with the current block may be determined. An SGPM candidate list associated with the current block may be obtained based on the determined SGPM candidate list size. The current block may be decoded using the SGPM candidate list. The characteristics may include the following: frame resolution, slice type, block size, and/or block shape.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a a system in which various aspects and examples may be implemented.

FIG. 5 shows an example of directional intra prediction with reference neighbor samples.

FIG. 6 shows an example of intra mode coding associated with 67 intra prediction modes (IPMs).

FIG. 7 shows an example of the current W×H block to be predicted with wide-angle intra predictions.

FIG. 8 shows an example of matrix weighted intra prediction (MIP).

FIG. 9 shows an example of decoder side intra prediction mode derivation (DIMD).

FIG. 10 shows an example of deriving IPMs of DIMD from gradients in a template.

FIG. 11 shows an example of a template used for deriving IPMs of fusion for template-based intra mode derivation (TIMD).

FIG. 12 shows an example of 4 reference lines associated with multiple reference line (MRL).

FIG. 13 shows an example of the intra-sub partition (ISP).

FIG. 14 shows an example of a most probable mode (MPM) list.

FIG. 15 shows an example of the signaling of the intra prediction mode selected to predict the current CU on the encoder side.

FIG. 16 shows an example of 64 partitions for geometric partition mode (GPM).

FIG. 17 shows an example blending in GPM.

FIG. 18 shows an example of GPM intra mode.

FIG. 19 shows an example of non-rectangular partitioning in inter prediction for a portion of a picture.

FIG. 20 shows an example of a piecewise smooth image model.

FIG. 21A shows an example of spatial geometric partition mode (SGPM).

FIG. 21B shows an example of a partition mode and two IPMs associated with SGPM signaled in video bitstream.

FIG. 21C shows a derived combination of a partition mode and two IPMs associated with SGPM signaled in a video bitstream.

FIG. 22 shows an example of a prediction obtained for the template with the partitioning weight extended to the template.

FIG. 23 shows an example of a flowchart of SGPM.

FIG. 24 shows an example of the signaling of the intra prediction mode selected to predict the current CU on the encoder side including adding SGPM.

FIG. 25 shows an example of the derivation of the possible IPM candidates for SGPM.

FIG. 26 shows an example of the selected possible partition mode candidates for SGPM.

FIG. 27 shows an example of reduced selected partition mode candidates proposed for SGPM.

FIG. 28 shows an example of checking and sorting possible combinations to derive the SGPM candidate list.

FIG. 29 shows an example of determining an IPM candidate list size based on characteristics.

FIG. 30 shows an example of determining a partition candidate list size based on characteristics.

FIG. 31 shows an example of determining an IPM candidate list size based on characteristics.

FIG. 32 shows an example of determining a partition candidate list size based on characteristics.

### DETAILED DESCRIPTION

A more detailed understanding can be had from the following description, given by way of example in conjunction with the accompanying drawings.

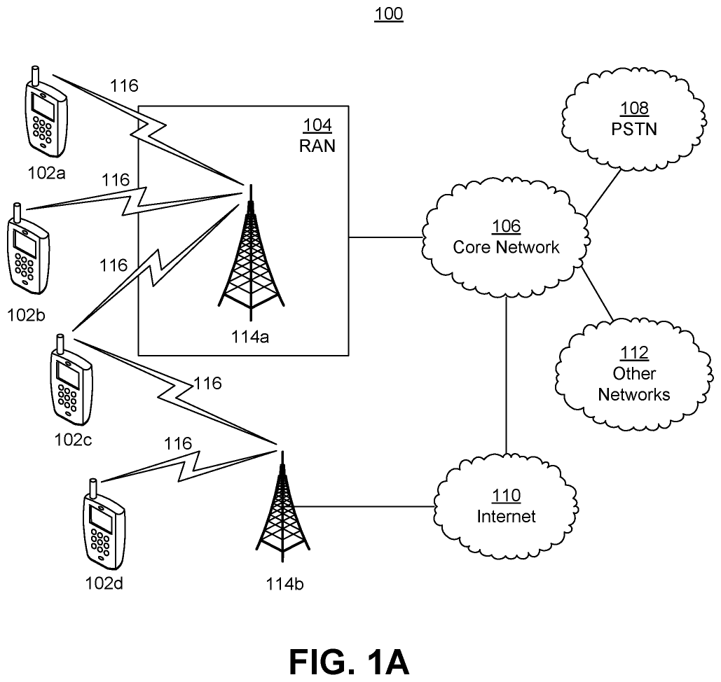

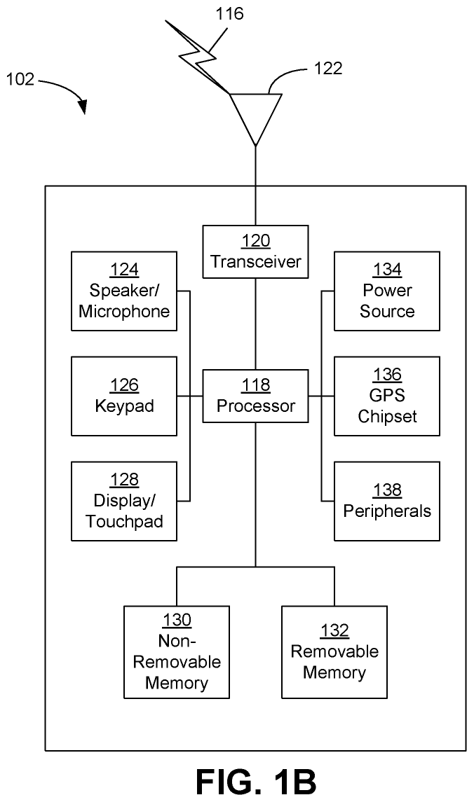

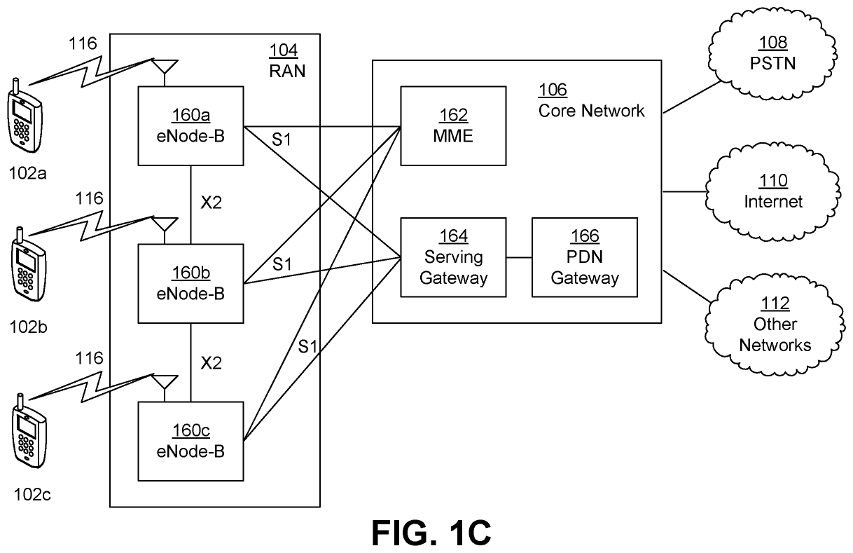

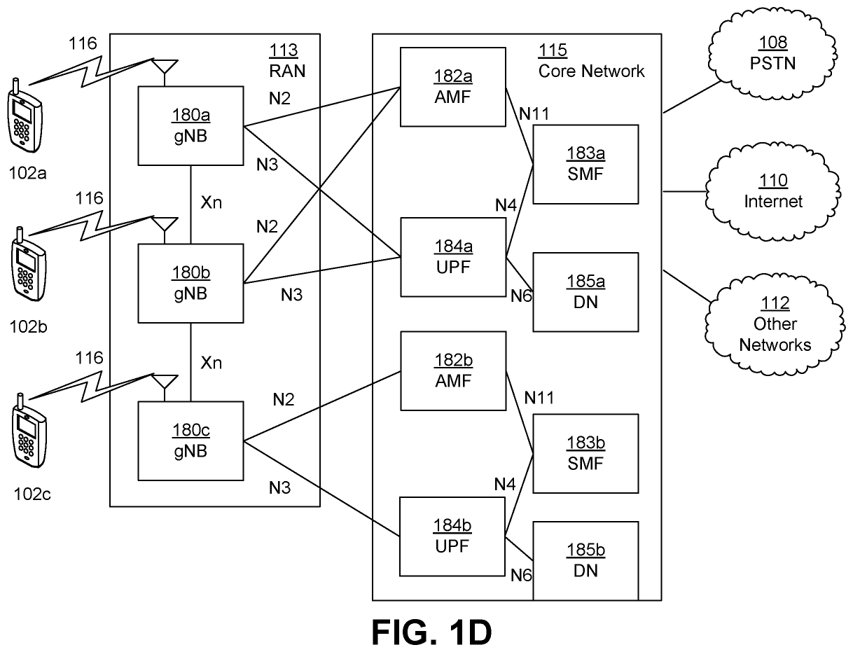

FIG. 1A is a diagram illustrating an example communications system 100 in which one or more disclosed embodiments can be implemented. The communications system 100 can be a multiple access system that provides content, such as voice, data, video, messaging, broadcast, etc., to multiple wireless users. The communications system 100 can enable multiple wireless users to access such content through the sharing of system resources, including wireless bandwidth. For example, the communications systems 100 can employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 can include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d can be any type of device configured to operate and/or communicate in a wireless environment. By way of example, the WTRUs 102a, 102b, 102c, 102d, any of which can be referred to as a “station” and/or a “STA”, can be configured to transmit and/or receive wireless signals and can include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d can be interchangeably referred to as a UE.

The communications systems 100 can also include a base station 114a and/or a base station 114b. Each of the base stations 114a, 114b can be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b can be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b can include any number of interconnected base stations and/or network elements.

The base station 114a can be part of the RAN 104/113, which can also include other base stations and/or network elements (not shown), such as a base station controller (BSC), a radio network controller (RNC), relay nodes, etc. The base station 114a and/or the base station 114b can be configured to transmit and/or receive wireless signals on one or more carrier frequencies, which can be referred to as a cell (not shown). These frequencies can be in licensed spectrum, unlicensed spectrum, or a combination of licensed and unlicensed spectrum. A cell can provide coverage for a wireless service to a specific geographical area that can be relatively fixed or that can change over time. The cell can further be divided into cell sectors. For example, the cell associated with the base station 114a can be divided into three sectors. Thus, in one embodiment, the base station 114a can include three transceivers, i.e., one for each sector of the cell. In an embodiment, the base station 114a can employ multiple-input multiple output (MIMO) technology and can utilize multiple transceivers for each sector of the cell. For example, beamforming can be used to transmit and/or receive signals in desired spatial directions.

The base stations 114a, 114b can communicate with one or more of the WTRUs 102a, 102b, 102c, 102d over an air interface 116, which can be any suitable wireless communication link (e.g., radio frequency (RF), microwave, centimeter wave, micrometer wave, infrared (IR), ultraviolet (UV), visible light, etc.). The air interface 116 can be established using any suitable radio access technology (RAT).

More specifically, as noted above, the communications system 100 can be a multiple access system and can employ one or more channel access schemes, such as CDMA, TDMA, FDMA, OFDMA, SC-FDMA, and the like. For example, the base station 114a in the RAN 104/113 and the WTRUs 102a, 102b, 102c can implement a radio technology such as Universal Mobile Telecommunications System (UMTS) Terrestrial Radio Access (UTRA), which can establish the air interface 115/116/117 using wideband CDMA (WCDMA). WCDMA can include communication protocols such as High-Speed Packet Access (HSPA) and/or Evolved HSPA (HSPA+). HSPA can include High-Speed Downlink (DL) Packet Access (HSDPA) and/or High-Speed UL Packet Access (HSUPA).

In an embodiment, the base station 114a and the WTRUs 102a, 102b, 102c can implement a radio technology such as Evolved UMTS Terrestrial Radio Access (E-UTRA), which can establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c can implement a radio technology such as NR Radio Access, which can establish the air interface 116 using New Radio (NR).

In an embodiment, the base station 114a and the WTRUs 102a, 102b, 102c can implement multiple radio access technologies. For example, the base station 114a and the WTRUs 102a, 102b, 102c can implement LTE radio access and NR radio access together, for instance using dual connectivity (DC) principles. Thus, the air interface utilized by WTRUs 102a, 102b, 102c can be characterized by multiple types of radio access technologies and/or transmissions sent to/from multiple types of base stations (e.g., a eNB and a gNB).

In other embodiments, the base station 114a and the WTRUs 102a, 102b, 102c can implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A can be a wireless router, Home Node B, Home eNode B, or access point, for example, and can utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d can implement a radio technology such as IEEE 802.11 to establish a wireless local area network (WLAN). In an embodiment, the base station 114b and the WTRUs 102c, 102d can implement a radio technology such as IEEE 802.15 to establish a wireless personal area network (WPAN). In yet another embodiment, the base station 114b and the WTRUs 102c, 102d can utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b can have a direct connection to the Internet 110. Thus, the base station 114b may not be required to access the Internet 110 via the CN 106/115.

The RAN 104/113 can be in communication with the CN 106/115, which can be any type of network configured to provide voice, data, applications, and/or voice over internet protocol (VoIP) services to one or more of the WTRUs 102a, 102b, 102c, 102d. The data can have varying quality of service (QOS) requirements, such as differing throughput requirements, latency requirements, error tolerance requirements, reliability requirements, data throughput requirements, mobility requirements, and the like. The CN 106/115 can provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 can be in direct or indirect communication with other RANs that employ the same RAT as the RAN 104/113 or a different RAT. For example, in addition to being connected to the RAN 104/113, which can be utilizing a NR radio technology, the CN 106/115 can also be in communication with another RAN (not shown) employing a GSM, UMTS, CDMA 2000, WiMAX, E-UTRA, or WiFi radio technology.

The CN 106/115 can also serve as a gateway for the WTRUs 102a, 102b, 102c, 102d to access the PSTN 108, the Internet 110, and/or the other networks 112. The PSTN 108 can include circuit-switched telephone networks that provide plain old telephone service (POTS). The Internet 110 can include a global system of interconnected computer networks and devices that use common communication protocols, such as the transmission control protocol (TCP), user datagram protocol (UDP) and/or the internet protocol (IP) in the TCP/IP internet protocol suite. The networks 112 can include wired and/or wireless communications networks owned and/or operated by other service providers. For example, the networks 112 can include another CN connected to one or more RANs, which can employ the same RAT as the RAN 104/113 or a different RAT.

Some or all of the WTRUs 102a, 102b, 102c, 102d in the communications system 100 can include multi-mode capabilities (e.g., the WTRUs 102a, 102b, 102c, 102d can include multiple transceivers for communicating with different wireless networks over different wireless links). For example, the WTRU 102c shown in FIG. 1A can be configured to communicate with the base station 114a, which can employ a cellular-based radio technology, and with the base station 114b, which can employ an IEEE 802 radio technology.

FIG. 1B is a system diagram illustrating an example WTRU 102. As shown in FIG. 1B, the WTRU 102 can include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 can include any sub-combination of the foregoing elements while remaining consistent with an embodiment.

The processor 118 can be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 can perform signal coding, data processing, power control, input/output processing, and/or any other functionality that enables the WTRU 102 to operate in a wireless environment. The processor 118 can be coupled to the transceiver 120, which can be coupled to the transmit/receive element 122. While FIG. 1B depicts the processor 118 and the transceiver 120 as separate components, it will be appreciated that the processor 118 and the transceiver 120 can be integrated together in an electronic package or chip.

The transmit/receive element 122 can be configured to transmit signals to, or receive signals from, a base station (e.g., the base station 114a) over the air interface 116. For example, in one embodiment, the transmit/receive element 122 can be an antenna configured to transmit and/or receive RF signals. In an embodiment, the transmit/receive element 122 can be an emitter/detector configured to transmit and/or receive IR, UV, or visible light signals, for example. In yet another embodiment, the transmit/receive element 122 can be configured to transmit and/or receive both RF and light signals. It will be appreciated that the transmit/receive element 122 can be configured to transmit and/or receive any combination of wireless signals.

Although the transmit/receive element 122 is depicted in FIG. 1B as a single element, the WTRU 102 can include any number of transmit/receive elements 122. More specifically, the WTRU 102 can employ MIMO technology. Thus, in one embodiment, the WTRU 102 can include two or more transmit/receive elements 122 (e.g., multiple antennas) for transmitting and receiving wireless signals over the air interface 116.

The transceiver 120 can be configured to modulate the signals that are to be transmitted by the transmit/receive element 122 and to demodulate the signals that are received by the transmit/receive element 122. As noted above, the WTRU 102 can have multi-mode capabilities. Thus, the transceiver 120 can include multiple transceivers for enabling the WTRU 102 to communicate via multiple RATs, such as NR and IEEE 802.11, for example.

The processor 118 of the WTRU 102 can be coupled to, and can receive user input data from, the speaker/microphone 124, the keypad 126, and/or the display/touchpad 128 (e.g., a liquid crystal display (LCD) display unit or organic light-emitting diode (OLED) display unit). The processor 118 can also output user data to the speaker/microphone 124, the keypad 126, and/or the display/touchpad 128. In addition, the processor 118 can access information from, and store data in, any type of suitable memory, such as the non-removable memory 130 and/or the removable memory 132. The non-removable memory 130 can include random-access memory (RAM), read-only memory (ROM), a hard disk, or any other type of memory storage device. The removable memory 132 can include a subscriber identity module (SIM) card, a memory stick, a secure digital (SD) memory card, and the like. In other embodiments, the processor 118 can access information from, and store data in, memory that is not physically located on the WTRU 102, such as on a server or a home computer (not shown).

The processor 118 can receive power from the power source 134, and can be configured to distribute and/or control the power to the other components in the WTRU 102. The power source 134 can be any suitable device for powering the WTRU 102. For example, the power source 134 can include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 can also be coupled to the GPS chipset 136, which can be configured to provide location information (e.g., longitude and latitude) regarding the current location of the WTRU 102. In addition to, or in lieu of, the information from the GPS chipset 136, the WTRU 102 can receive location information over the air interface 116 from a base station (e.g., base stations 114a, 114b) and/or determine its location based on the timing of the signals being received from two or more nearby base stations. It will be appreciated that the WTRU 102 can acquire location information by way of any suitable location-determination method while remaining consistent with an embodiment.

The processor 118 can further be coupled to other peripherals 138, which can include one or more software and/or hardware modules that provide additional features, functionality and/or wired or wireless connectivity. For example, the peripherals 138 can include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 can include one or more sensors, the sensors can be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 can include a full duplex radio for which transmission and reception of some or all of the signals (e.g., associated with particular subframes for both the UL (e.g., for transmission) and downlink (e.g., for reception) can be concurrent and/or simultaneous. The full duplex radio can include an interference management unit to reduce and or substantially eliminate self-interference via either hardware (e.g., a choke) or signal processing via a processor (e.g., a separate processor (not shown) or via processor 118). In an embodiment, the WRTU 102 can include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 can employ an E-UTRA radio technology to communicate with the WTRUs 102a, 102b, 102c over the air interface 116. The RAN 104 can also be in communication with the CN 106.

The RAN 104 can include eNode-Bs 160a, 160b, 160c, though it will be appreciated that the RAN 104 can include any number of eNode-Bs while remaining consistent with an embodiment. The eNode-Bs 160a, 160b, 160c can each include one or more transceivers for communicating with the WTRUs 102a, 102b, 102c over the air interface 116. In one embodiment, the eNode-Bs 160a, 160b, 160c can implement MIMO technology. Thus, the eNode-B 160a, for example, can use multiple antennas to transmit wireless signals to, and/or receive wireless signals from, the WTRU 102a.

Each of the eNode-Bs 160a, 160b, 160c can be associated with a particular cell (not shown) and can be configured to handle radio resource management decisions, handover decisions, scheduling of users in the UL and/or DL, and the like. As shown in FIG. 1C, the eNode-Bs 160a, 160b, 160c can communicate with one another over an X2 interface.

The CN 106 shown in FIG. 1C can include a mobility management entity (MME) 162, a serving gateway (SGW) 164, and a packet data network (PDN) gateway (or PGW) 166. While each of the foregoing elements are depicted as part of the CN 106, it will be appreciated that any of these elements can be owned and/or operated by an entity other than the CN operator.

The MME 162 can be connected to each of the eNode-Bs 162a, 162b, 162c in the RAN 104 via an S1 interface and can serve as a control node. For example, the MME 162 can be responsible for authenticating users of the WTRUs 102a, 102b, 102c, bearer activation/deactivation, selecting a particular serving gateway during an initial attach of the WTRUs 102a, 102b, 102c, and the like. The MME 162 can provide a control plane function for switching between the RAN 104 and other RANs (not shown) that employ other radio technologies, such as GSM and/or WCDMA.

The SGW 164 can be connected to each of the eNode Bs 160a, 160b, 160c in the RAN 104 via the S1 interface. The SGW 164 can generally route and forward user data packets to/from the WTRUs 102a, 102b, 102c. The SGW 164 can perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 can be connected to the PGW 166, which can provide the WTRUs 102a, 102b, 102c with access to packet-switched networks, such as the Internet 110, to facilitate communications between the WTRUs 102a, 102b, 102c and IP-enabled devices.

The CN 106 can facilitate communications with other networks. For example, the CN 106 can provide the WTRUs 102a, 102b, 102c with access to circuit-switched networks, such as the PSTN 108, to facilitate communications between the WTRUs 102a, 102b, 102c and traditional land-line communications devices. For example, the CN 106 can include, or can communicate with, an IP gateway (e.g., an IP multimedia subsystem (IMS) server) that serves as an interface between the CN 106 and the PSTN 108. In addition, the CN 106 can provide the WTRUs 102a, 102b, 102c with access to the other networks 112, which can include other wired and/or wireless networks that are owned and/or operated by other service providers.

Although the WTRU is described in FIGS. 1A-1D as a wireless terminal, it is contemplated that in certain representative embodiments that such a terminal can use (e.g., temporarily or permanently) wired communication interfaces with the communication network.

In representative embodiments, the other network 112 can be a WLAN.

A WLAN in Infrastructure Basic Service Set (BSS) mode can have an Access Point (AP) for the BSS and one or more stations (STAs) associated with the AP. The AP can have an access or an interface to a Distribution System (DS) or another type of wired/wireless network that carries traffic in to and/or out of the BSS. Traffic to STAs that originates from outside the BSS can arrive through the AP and can be delivered to the STAs. Traffic originating from STAs to destinations outside the BSS can be sent to the AP to be delivered to respective destinations. Traffic between STAs within the BSS can be sent through the AP, for example, where the source STA can send traffic to the AP and the AP can deliver the traffic to the destination STA. The traffic between STAs within a BSS can be considered and/or referred to as peer-to-peer traffic. The peer-to-peer traffic can be sent between (e.g., directly between) the source and destination STAs with a direct link setup (DLS). In certain representative embodiments, the DLS can use an 802.11e DLS or an 802.11z tunneled DLS (TDLS). A WLAN using an Independent BSS (IBSS) mode may not have an AP, and the STAs (e.g., all of the STAs) within or using the IBSS can communicate directly with each other. The IBSS mode of communication can sometimes be referred to herein as an “ad-hoc” mode of communication.

When using the 802.11ac infrastructure mode of operation or a similar mode of operations, the AP can transmit a beacon on a fixed channel, such as a primary channel. The primary channel can be a fixed width (e.g., 20 MHz wide bandwidth) or a dynamically set width via signaling. The primary channel can be the operating channel of the BSS and can be used by the STAs to establish a connection with the AP. In certain representative embodiments, Carrier Sense Multiple Access with Collision Avoidance (CSMA/CA) can be implemented, for example in 802.11 systems. For CSMA/CA, the STAs (e.g., every STA), including the AP, can sense the primary channel. If the primary channel is sensed/detected and/or determined to be busy by a particular STA, the particular STA can back off. One STA (e.g., only one station) can transmit at any given time in a given BSS.

High Throughput (HT) STAs can use a 40 MHz wide channel for communication, for example, via a combination of the primary 20 MHz channel with an adjacent or nonadjacent 20 MHz channel to form a 40 MHz wide channel.

Very High Throughput (VHT) STAs can support 20 MHz, 40 MHZ, 80 MHz, and/or 160 MHz wide channels. The 40 MHz, and/or 80 MHz, channels can be formed by combining contiguous 20 MHz channels. A 160 MHz channel can be formed by combining 8 contiguous 20 MHz channels, or by combining two non-contiguous 80 MHz channels, which can be referred to as an 80+80 configuration. For the 80+80 configuration, the data, after channel encoding, can be passed through a segment parser that can divide the data into two streams. Inverse Fast Fourier Transform (IFFT) processing, and time domain processing, can be done on each stream separately. The streams can be mapped on to the two 80 MHz channels, and the data can be transmitted by a transmitting STA. At the receiver of the receiving STA, the above described operation for the 80+80 configuration can be reversed, and the combined data can be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah can support Meter Type Control/Machine-Type Communications, such as MTC devices in a macro coverage area. MTC devices can have certain capabilities, for example, limited capabilities including support for (e.g., only support for) certain and/or limited bandwidths. The MTC devices can include a battery with a battery life above a threshold (e.g., to maintain a very long battery life).

WLAN systems, which can support multiple channels, and channel bandwidths, such as 802.11n, 802.11ac, 802.11af, and 802.11ah, include a channel which can be designated as the primary channel. The primary channel can have a bandwidth equal to the largest common operating bandwidth supported by all STAs in the BSS. The bandwidth of the primary channel can be set and/or limited by a STA, from among all STAs in operating in a BSS, which supports the smallest bandwidth operating mode. In the example of 802.11ah, the primary channel can be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings can depend on the status of the primary channel. If the primary channel is busy, for example, due to a STA (which supports only a 1 MHz operating mode), transmitting to the AP, the entire available frequency bands can be considered busy even though a majority of the frequency bands remains idle and can be available.

In the United States, the available frequency bands, which can be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 can employ an NR radio technology to communicate with the WTRUs 102a, 102b, 102c over the air interface 116. The RAN 113 can also be in communication with the CN 115.

The RAN 113 can include gNBs 180a, 180b, 180c, though it will be appreciated that the RAN 113 can include any number of gNBs while remaining consistent with an embodiment. The gNBs 180a, 180b, 180c can each include one or more transceivers for communicating with the WTRUs 102a, 102b, 102c over the air interface 116. In one embodiment, the gNBs 180a, 180b, 180c can implement MIMO technology. For example, gNBs 180a, 108b can utilize beamforming to transmit signals to and/or receive signals from the gNBs 180a, 180b, 180c. Thus, the gNB 180a, for example, can use multiple antennas to transmit wireless signals to, and/or receive wireless signals from, the WTRU 102a. In an embodiment, the gNBs 180a, 180b, 180c can implement carrier aggregation technology. For example, the gNB 180a can transmit multiple component carriers to the WTRU 102a (not shown). A subset of these component carriers can be on unlicensed spectrum while the remaining component carriers can be on licensed spectrum. In an embodiment, the gNBs 180a, 180b, 180c can implement Coordinated Multi-Point (COMP) technology. For example, WTRU 102a can receive coordinated transmissions from gNB 180a and gNB 180b (and/or gNB 180c).

The WTRUs 102a, 102b, 102c can communicate with gNBs 180a, 180b, 180c using transmissions associated with a scalable numerology. For example, the OFDM symbol spacing and/or OFDM subcarrier spacing can vary for different transmissions, different cells, and/or different portions of the wireless transmission spectrum. The WTRUs 102a, 102b, 102c can communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c can be configured to communicate with the WTRUs 102a, 102b, 102c in a standalone configuration and/or a non-standalone configuration. In the standalone configuration, WTRUs 102a, 102b, 102c can communicate with gNBs 180a, 180b, 180c without also accessing other RANs (e.g., such as eNode-Bs 160a, 160b, 160c). In the standalone configuration, WTRUs 102a, 102b, 102c can utilize one or more of gNBs 180a, 180b, 180c as a mobility anchor point. In the standalone configuration, WTRUs 102a, 102b, 102c can communicate with gNBs 180a, 180b, 180c using signals in an unlicensed band. In a non-standalone configuration WTRUs 102a, 102b, 102c can communicate with/connect to gNBs 180a, 180b, 180c while also communicating with/connecting to another RAN such as eNode-Bs 160a, 160b, 160c. For example, WTRUs 102a, 102b, 102c can implement DC principles to communicate with one or more gNBs 180a, 180b, 180c and one or more eNode-Bs 160a, 160b, 160c substantially simultaneously. In the non-standalone configuration, eNode-Bs 160a, 160b, 160c can serve as a mobility anchor for WTRUs 102a, 102b, 102c and gNBs 180a, 180b, 180c can provide additional coverage and/or throughput for servicing WTRUs 102a, 102b, 102c.

Each of the gNBs 180a, 180b, 180c can be associated with a particular cell (not shown) and can be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c can communicate with one another over an Xn interface.

The CN 115 shown in FIG. 1D can include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements can be owned and/or operated by an entity other than the CN operator.

The AMF 182a, 182b can be connected to one or more of the gNBs 180a, 180b, 180c in the RAN 113 via an N2 interface and can serve as a control node. For example, the AMF 182a, 182b can be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing can be used by the AMF 182a, 182b in order to customize CN support for WTRUs 102a, 102b, 102c based on the types of services being utilized WTRUs 102a, 102b, 102c. For example, different network slices can be established for different use cases such as services relying on ultra-reliable low latency (URLLC) access, services relying on enhanced massive mobile broadband (eMBB) access, services for machine type communication (MTC) access, and/or the like. The AMF 162 can provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b can be connected to an AMF 182a, 182b in the CN 115 via an N11 interface. The SMF 183a, 183b can also be connected to a UPF 184a, 184b in the CN 115 via an N4 interface. The SMF 183a, 183b can select and control the UPF 184a, 184b and configure the routing of traffic through the UPF 184a, 184b. The SMF 183a, 183b can perform other functions, such as managing and allocating UE IP address, managing PDU sessions, controlling policy enforcement and QoS, providing downlink data notifications, and the like. A PDU session type can be IP-based, non-IP based, Ethernet-based, and the like.

The UPF 184a, 184b can be connected to one or more of the gNBs 180a, 180b, 180c in the RAN 113 via an N3 interface, which can provide the WTRUs 102a, 102b, 102c with access to packet-switched networks, such as the Internet 110, to facilitate communications between the WTRUs 102a, 102b, 102c and IP-enabled devices. The UPF 184, 184b can perform other functions, such as routing and forwarding packets, enforcing user plane policies, supporting multi-homed PDU sessions, handling user plane QoS, buffering downlink packets, providing mobility anchoring, and the like.

The CN 115 can facilitate communications with other networks. For example, the CN 115 can include, or can communicate with, an IP gateway (e.g., an IP multimedia subsystem (IMS) server) that serves as an interface between the CN 115 and the PSTN 108. In addition, the CN 115 can provide the WTRUs 102a, 102b, 102c with access to the other networks 112, which can include other wired and/or wireless networks that are owned and/or operated by other service providers. In one embodiment, the WTRUs 102a, 102b, 102c can be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, can be performed by one or more emulation devices (not shown). The emulation devices can be one or more devices configured to emulate one or more, or all, of the functions described herein. For example, the emulation devices can be used to test other devices and/or to simulate network and/or WTRU functions.

The emulation devices can be designed to implement one or more tests of other devices in a lab environment and/or in an operator network environment. For example, the one or more emulation devices can perform the one or more, or all, functions while being fully or partially implemented and/or deployed as part of a wired and/or wireless communication network in order to test other devices within the communication network. The one or more emulation devices can perform the one or more, or all, functions while being temporarily implemented/deployed as part of a wired and/or wireless communication network. The emulation device can be directly coupled to another device for purposes of testing and/or can perform testing using over-the-air wireless communications.

The one or more emulation devices can perform the one or more, including all, functions while not being implemented/deployed as part of a wired and/or wireless communication network. For example, the emulation devices can be utilized in a testing scenario in a testing laboratory and/or a non-deployed (e.g., testing) wired and/or wireless communication network in order to implement testing of one or more components. The one or more emulation devices can be test equipment. Direct RF coupling and/or wireless communications via RF circuitry (e.g., which can include one or more antennas) can be used by the emulation devices to transmit and/or receive data.

This application describes a variety of aspects, including tools, features, examples, models, approaches, etc. Many of these aspects are described with specificity and, at least to show the individual characteristics, are often described in a manner that can sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

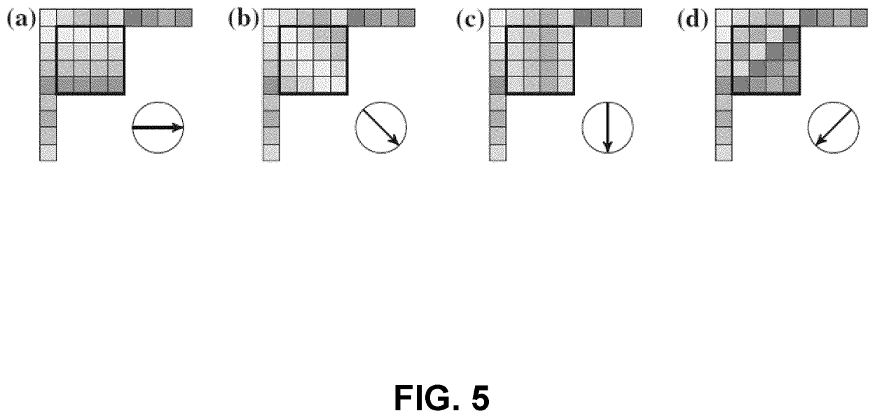

The aspects described and contemplated in this application can be implemented in many different forms. FIGS. 5-32 described herein can provide some examples, but other examples are contemplated. The discussion of FIGS. 5-32 does not limit the breadth of the implementations. At least one of the aspects generally relates to video encoding and decoding, and at least one other aspect generally relates to generating a bitstream, storing a bitstream, and/or transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described. As used herein, a bitstream may or may not be transmitted.

In the present application, the terms “reconstructed” and “decoded” can be used interchangeably, the terms “pixel” and “sample” can be used interchangeably, the terms “image,” “picture” and “frame” can be used interchangeably.

Various methods are described herein, and each of the methods comprises one or more steps or actions for achieving the described method. Unless a specific order of steps or actions is required for proper operation of the method, the order and/or use of specific steps and/or actions can be modified or combined. Additionally, terms such as “first”, “second”, etc. can be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and can occur, for example, before, during, or in an overlapping time period with the second decoding.

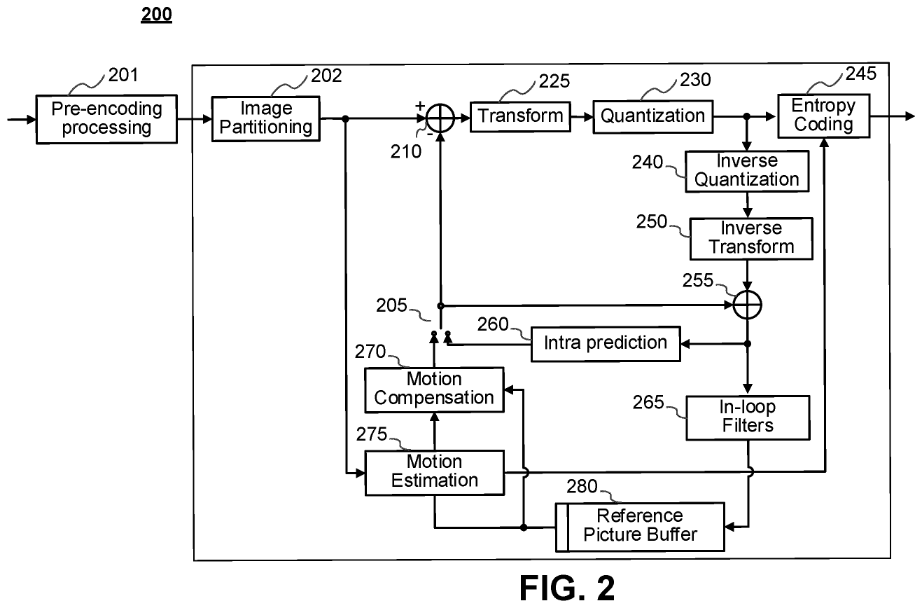

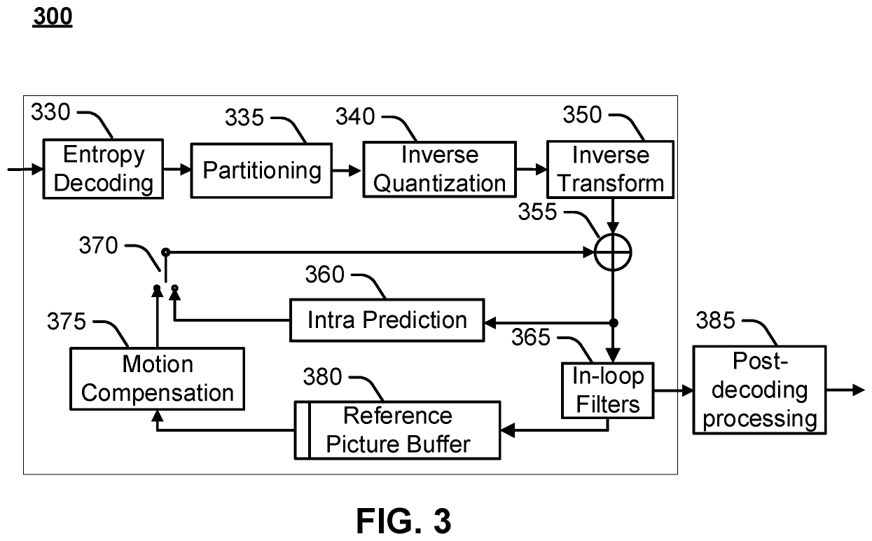

Various methods and other aspects described in this application can be used to modify modules, for example, decoding modules, of a video encoder 200 and decoder 300 as shown in FIG. 2 and FIG. 3. Moreover, the subject matter disclosed herein can be applied, for example, to any type, format or version of video coding, whether described in a standard or a recommendation, whether pre-existing or future-developed, and extensions of any such standards and recommendations. Unless indicated otherwise, or technically precluded, the aspects described in this application can be used individually or in combination.

Various numeric values are used in examples described the present application, such as 0, 1, 2, 3, 4, 6, 7, 8, 11, 16, 18, 26, 33, 45, 50, 64, 65, 66, 67, 80, 129, 131, 135, 1456, etc. These and other specific values are for purposes of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence can go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder can therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream. In an example, the decoded images (e.g., after application of the in-loop filters (365) and/or after post-decoding processing (385), if post-decoding processing is used) can be sent to a display device for rendering to a user.

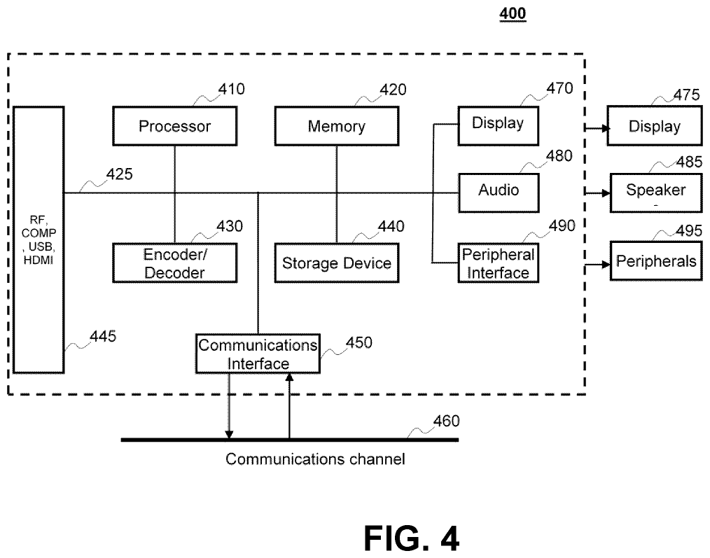

FIG. 4 is a diagram showing an example of a system in which various aspects and examples described herein can be implemented. System 400 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, can be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that can be included in a device to perform the encoding and/or decoding functions. As is known, a device can include one or both of the encoding and decoding modules. Additionally, encoder/decoder module 430 can be implemented as a separate element of system 400 or can be incorporated within processor 410 as a combination of hardware and software as known to those skilled in the art.

Program code to be loaded onto processor 410 or encoder/decoder 430 to perform the various aspects described in this document can be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device can be either the processor 410 or the encoder/decoder module 430) is used for one or more of these functions. The external memory can be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 can be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, can be implemented, for example, within a separate input processing IC or within processor 410 as necessary. Similarly, aspects of USB or HDMI interface processing can be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 can be provided within an integrated housing, Within the integrated housing, the various elements can be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 can be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 can be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices can be communicatively coupled to system 400 via dedicated connections through respective interfaces 470, 480, and 490. Alternatively, the output devices can be connected to system 400 using the communications channel 460 via the communications interface 450. The display 475 and speakers 485 can be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal can be provided via dedicated output connections, including, for example, HDMI ports, USB ports, or COMP outputs.

The examples can be carried out by computer software implemented by the processor 410 or by hardware, or by a combination of hardware and software. As a non-limiting example, the examples can be implemented by one or more integrated circuits. The memory 420 can be of any type appropriate to the technical environment and can be implemented using any appropriate data storage technology, such as optical memory devices, magnetic memory devices, semiconductor-based memory devices, fixed memory, and removable memory, as non-limiting examples. The processor 410 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, deriving a first candidate intra prediction mode (IPM) based on a first template of a coding block; deriving a second candidate IPM based on a second template of the coding block; and decoding the coding block based on the first candidate IPM and the second candidate IPM.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, deriving a first candidate intra prediction mode (IPM) based on a first template of a coding block; deriving a second candidate IPM based on a second template of the coding block; and encoding the coding block based on the first candidate IPM and the second candidate IPM.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, coding syntax on number of partition modes, number of intra prediction mode candidates, number of inter prediction mode candidates, number of partition mode candidates, block size, partitions, partition modes, slice type, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application can refer to “determining” various pieces of information. Determining the information can include one or more of, for example, estimating the information, calculating the information, predicting the information, or retrieving the information from memory. Obtaining can include receiving, retrieving, constructing, generating, and/or determining.

Further, this application can refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application can refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as is clear to one of ordinary skill in this and related arts, for as many items as are listed.

Also, as used herein, the word “signal” refers to, among other things, indicating something to a corresponding decoder. Encoder signals can include, for example, intra prediction mode candidates, number of partition mode candidates, block size, slice type, etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various examples. It is to be appreciated that signaling can be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described example. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on, or accessed or received from, a processor-readable medium.

Many examples are described herein. Features of examples can be provided alone or in any combination, across various claim categories and types. Further, examples can include one or more of the features, devices, or aspects described herein, alone or in any combination, across various claim categories and types. For example, features described herein can be implemented in a bitstream or signal that includes information generated as described herein. The information can allow a decoder to decode a bitstream, the encoder, bitstream, and/or decoder according to any of the embodiments described. For example, features described herein can be implemented by creating and/or transmitting and/or receiving and/or decoding a bitstream or signal. For example, features described herein can be implemented a method, process, apparatus, medium storing instructions, medium storing data, or signal. For example, features described herein can be implemented by a TV, set-top box, cell phone, tablet, or other electronic device that performs decoding. The TV, set-top box, cell phone, tablet, or other electronic device can display (e.g., using a monitor, screen, or other type of display) a resulting image (e.g., an image from residual reconstruction of the video bitstream). The TV, set-top box, cell phone, tablet, or other electronic device can receive a signal including an encoded image and perform decoding.

Intra prediction may be used to exploit a correlation within local regions of a picture. For intra prediction, texture of a picture region may be similar to the texture in a local neighborhood and may be predicted from there. The neighbor samples, such as samples from the sample line above the current block and samples from the last column of the reconstructed blocks to the left of the current block, may be employed for prediction.

The reference neighbor samples which are used for predicting the current block may depend on the direction indicated by the intra prediction angle of the respective intra prediction mode (IPM). FIG. 5 shows an example of directional intra prediction with reference neighbor samples. For example, for a horizontal prediction, the reference neighbor samples from the left column may be used. For vertical prediction, the reference neighbor samples from the above row may be used. For diagonal down right prediction, the reference neighbor samples from the above-left side may be applied. The reference neighbor samples from the above-right side may be applied for diagonal down left prediction.

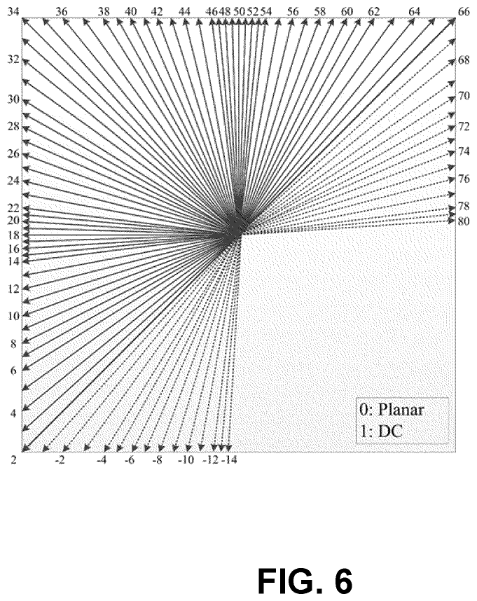

FIG. 6 shows an example of intra mode coding associated with 67 IPMs. To capture the arbitrary edge directions presented in a video, the number of directional intra modes may be extended from 33 to 65, as depicted in FIG. 6, and the number of planar and DC modes may remain the same. Dense directional IPMs may apply for block sizes and for luma and chroma intra predictions.

For a square CU, the angular IPMs 2-66 may be used. The prediction modes may correspond to angular intra prediction directions that are defined from 45 degrees to 135 degrees, e.g., in a clockwise direction.

Wide-angle intra prediction may be used for non-square blocks. Multiple angular IPMs may be replaced (e.g., adaptively replaced) with wide angular IPMs for non-square blocks. As shown by the dotted arrows in FIG. 6, the wide angular modes beyond the bottom-left direction modes may be indexed from 14 to 1 and the wide angular modes beyond the top-right direction may be indexed from 67 to 80. Flat blocks (W>H) and tall blocks (W<H) may use wide angular modes to replace an equal number of regular angular modes in the opposite direction.

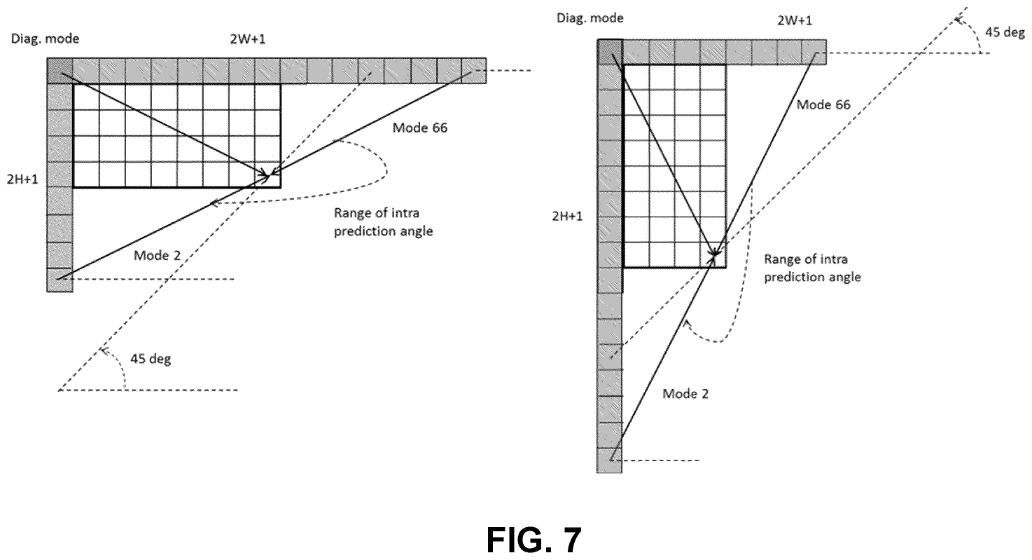

FIG. 7 shows an example of the current W×H block to be predicted with wide-angle intra predictions. As shown in FIG. 7, a set of decoded reference samples may be used for the current W×H block to be predicted. The set of decoded reference samples may include an array of top decoded reference samples of length 2 W+1 and an array of left decoded reference samples of length 2H+1. As shown in FIG. 7, a relationship between the extent of the decoded reference samples around the current W×H block and the range of allowed intra prediction angles may be provided.

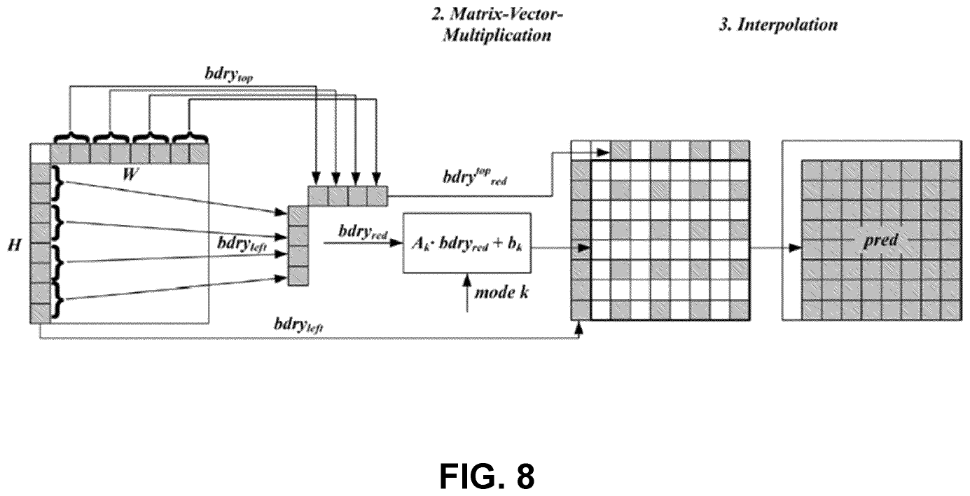

FIG. 8 shows an example of matrix weighted intra prediction (MIP). For predicting the samples of a rectangular block of width W and height H, MIP may take a line of H reconstructed neighboring boundary samples left of the block and a line of W reconstructed neighboring boundary samples above the block as input. In examples, if the reconstructed samples are unavailable, the reconstructed samples may be generated using intra prediction (e.g., non-matrix weighted intra prediction). The generation of the prediction signal may be based on one or more of the following: averaging, matrix vector multiplication, and/or linear interpolation (e.g., as shown in FIG. 8).

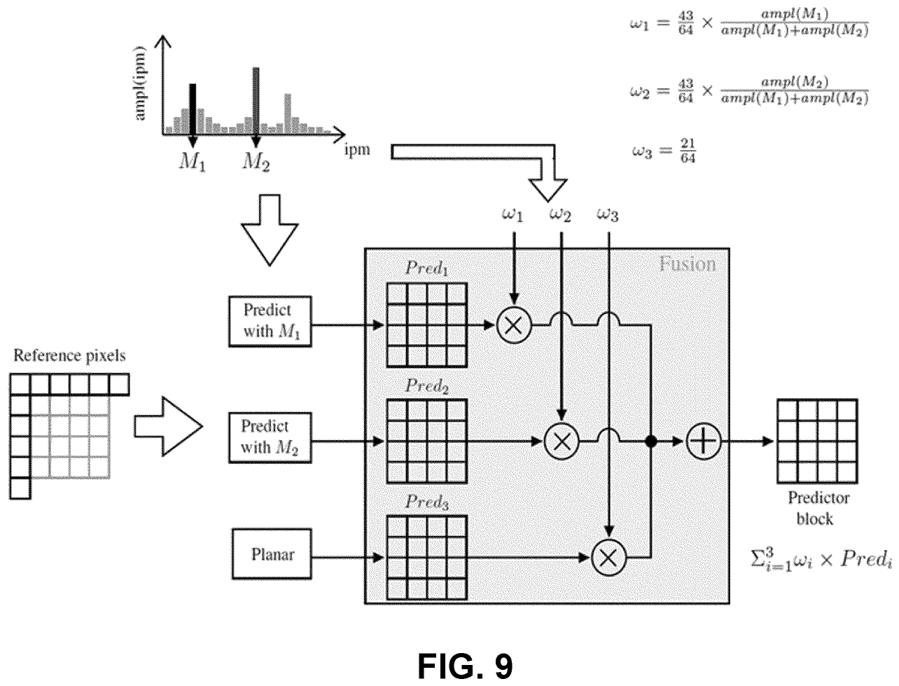

For an intra-coded block, a flag mip_flag indicating whether an MIP mode is to be applied may be signaled. Decoder-side intra mode derivation (DIMD) may be used to derive the intra mode used to code a coding unit (CU). FIG. 9 shows an example of DIMD. In examples, if a DIMD is applied, IPMs (e.g., two IPMs) that are likely the best IPMs (e.g., two best IPMs) for predicting the current CU may be derived from a histogram of oriented gradients (HOG) computed from the neighboring pixels of a current block. The IPMs (e.g., the two predictors) may be combined with the planar mode predictor with the weights derived from the HOG in the template, as shown in FIG. 9.

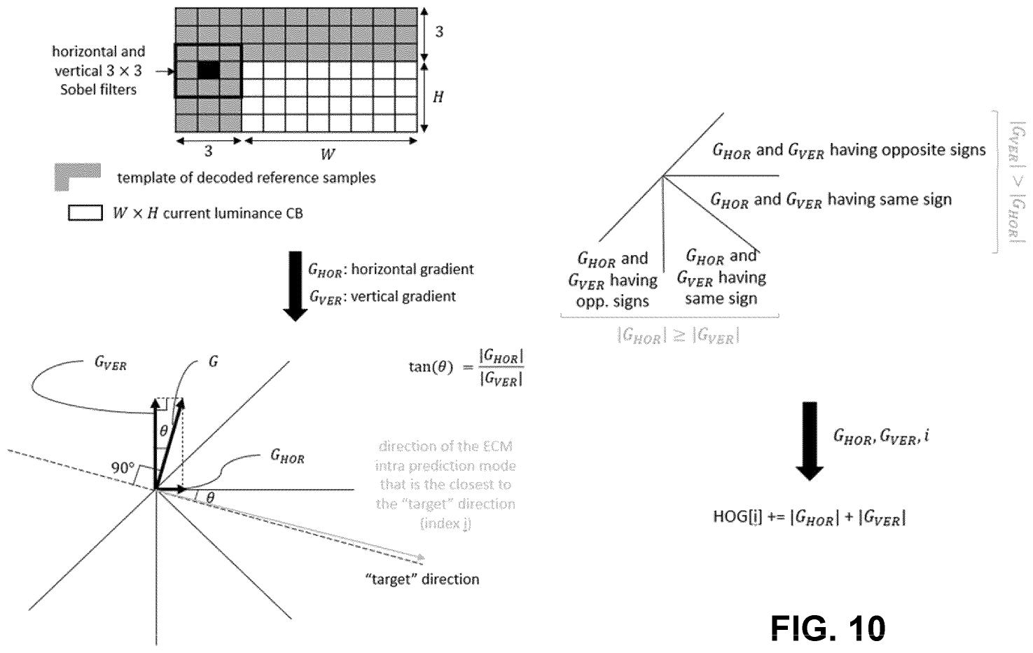

FIG. 10 shows an example of deriving IPMs of DIMD from gradients in a template. In examples, for the current CU, the IPMs (e.g., two IPMs) can be derived from the gradients in the template as shown in FIG. 10. A HOG with 65 bins, corresponding to the 65 directional IPMs, may be initialized to 0. For a decoded reference sample in the middle row or the middle column of the template of three rows of decoded reference samples above the current CU and three columns of decoded reference samples on a left side of the current CU, one or more of the following may apply. A 3×3 horizontal sobel filter and a 3×3 vertical sobel filter, both centered at this decoded reference sample, may yield a horizontal gradient G_{HOR} and a vertical gradient G_{VER}, respectively. The signs of G_{HOR} and G_{VER} may indicate in which of the ranges (e.g., four ranges) of directions the target direction is found which is perpendicular to the gradient G of horizontal component G_{HOR} and vertical component G_{VER}. In examples, if |G_{VER}|>|G_{HOR}|, the anchor direction may correspond to the horizontal direction. In examples, if |G_{HOR}|≥|G_{VER}|, the anchor direction may correspond to the vertical direction. The target direction may form an angle θ with respect to the anchor direction. By discretizing a scaled version of tan (θ), the index i of the IPM whose direction is the closest to the target direction may be found. The HOG bin of index i may be incremented by |G_{HOR}|+|G_{VER}|. The indices of the largest HOG bins (e.g., two largest HOG bins) may be the indices of the derived IPMs (e.g., two derived IPMs). For an intra-coded block, a flag dimd_flag indicating whether a DIMD mode is to be applied may be signaled.

Fusion may be used for template-based intra mode derivation (TIMD). The intra mode used to code a CU derived using the fusion for TIMD may be described herein.

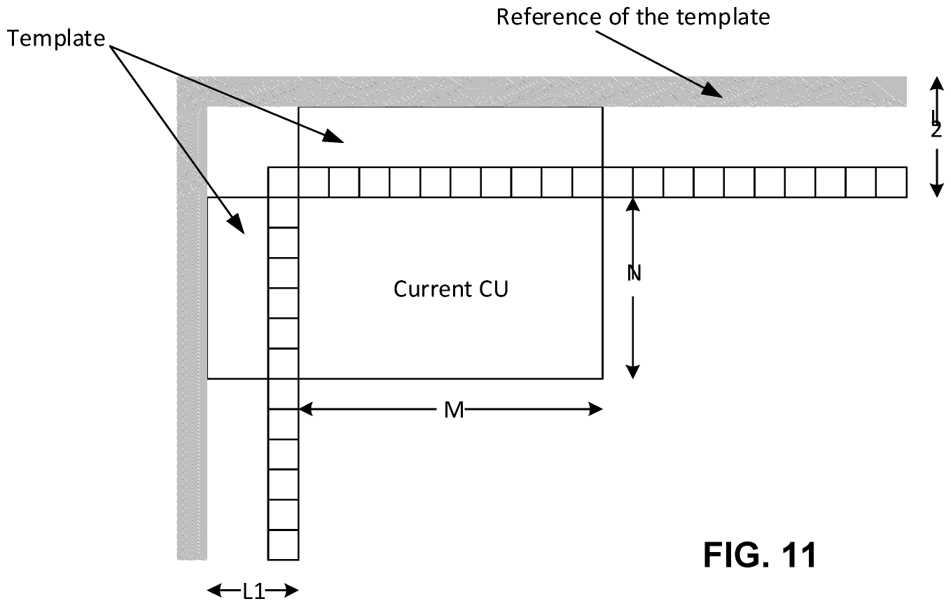

FIG. 11 shows an example of a template used for deriving IPMs of fusion for TIMD. For an IPM in most probable modes (MPMs), the sum of absolute transformed differences (SATD) between the prediction and reconstruction samples of the template may be calculated as shown in FIG. 11. The IPMs (e.g., first two IPMs) with the minimum SATD may be selected. For TIMD, the set of directional IPMs may be extended from 65 to 129 by inserting a direction between the black solid arrow as shown in FIG. 6. This may mean that the set of possible IPMs derived via TIMD gathers 131 modes. Based on retaining IPMs (e.g., two IPMs) from the first pass of tests involving the MPM list supplemented with default modes, for the modes (e.g., one or more of the two modes), if the IPM is neither PLANAR nor DC, TIMD may test in terms of prediction SATD its two closest extended directional IPMs. Based on a condition that SATD_{IPM2}<2*SATD_{IPM1} is true, these selected IPMs (e.g., final two selected IPMs) may be fused with the weights, which may be depended on the SATDs of the IPMs (e.g., two IPMs); otherwise, the first IPM may be used. For an intra-coded block, a flag timd_flag indicating whether a TIMD mode is to be applied is signaled.

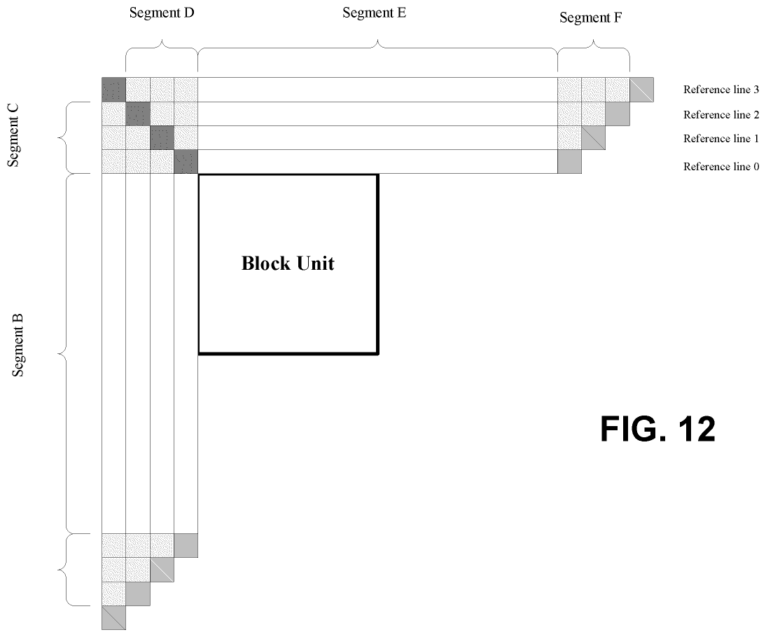

Multiple reference line (MRL) intra prediction may use more reference lines for intra prediction. FIG. 12 shows an example of 4 reference lines associated with MRL. The samples of segments A and F may not be fetched from reconstructed neighboring samples and may be padded with the closest samples from Segment B and E, respectively. Intra-picture prediction may use the nearest reference line (e.g., reference line 0). In MRL, 2 lines (e.g., additional lines such as reference line 1 and reference line 3) may be used. The index of selected reference line mrl_idx may be signaled and used to generate intra predictor.

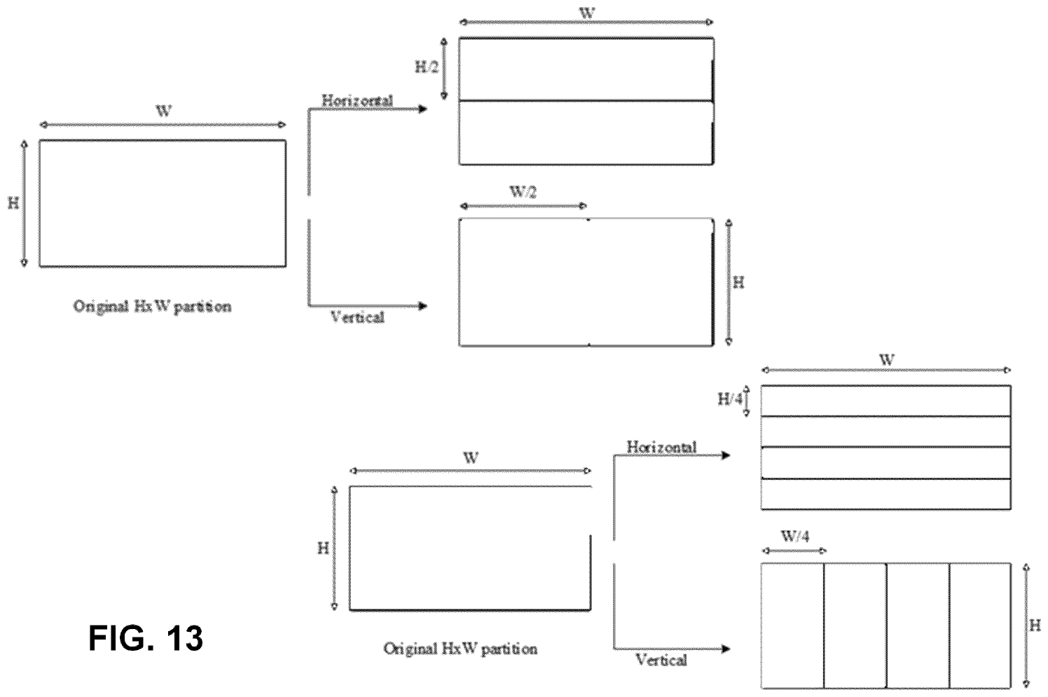

Intra sub-partitions (ISP) may be used to divide luma intra-predicted blocks vertically or horizontally into 2 or 4 sub-partitions depending on the block size. FIG. 13 shows an example of the ISP. The reconstructed sample values of a sub-partition may be available to generate the prediction of the next sub-partition and a sub-partition may be processed repeatedly. The sub-partition may fulfill the condition of having at least 16 samples and may share the same intra mode.

For an intra-coded block, a flag isp_flag indicating whether ISP is to be applied may be signaled. Syntax isp_mode may specify the split vertically or horizontally and may be signaled based on a condition that isp_flag is true.

Intra prediction mode signaling may be provided. In examples, if the intra prediction mode selected to predict the current CU is not a DIMD, MIP mode, or a TIMD (e.g., it is one of the 67 IPMs as described herein), the index of the intra prediction mode may be signaled using the MPM list of the CU. Block differential pulse code modulation (BDPCM), template-based intra prediction (TMP), intra block copy (IBC), and palette coding may be activated for video sequences (e.g., exclusively, such as screen content), and may be disabled when MPM list is used.

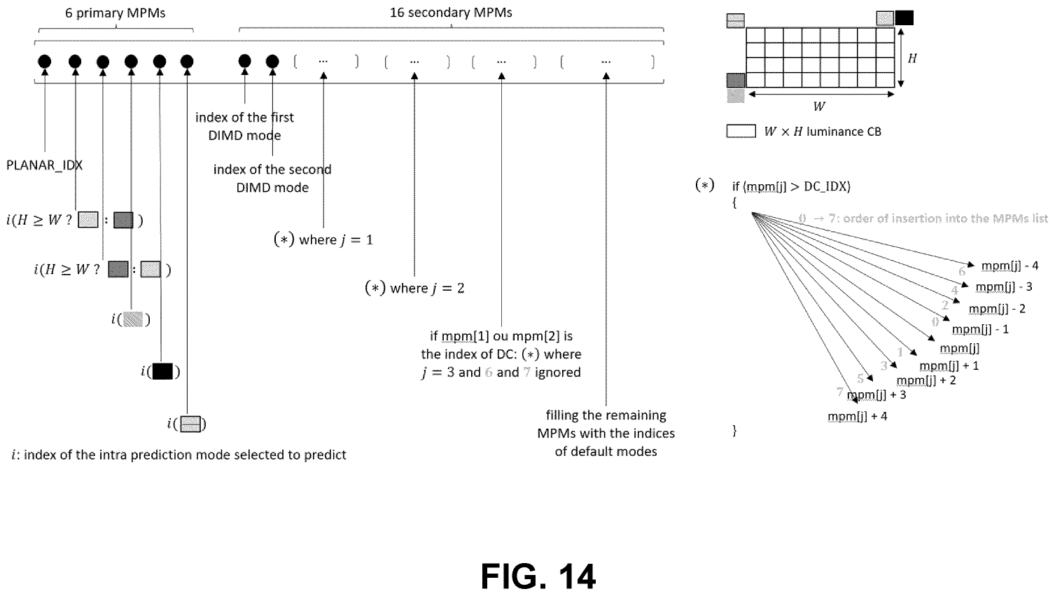

An MPM list may include a list of primary MPMs (e.g., 6 primary MPMs) and a list of secondary MPMs (e.g., 16 secondary MPMs), as shown in FIG. 14. FIG. 14 shows an example of an MPM list. The MPM list may be built by sequentially adding candidate IPM indices, from the one most likely to be selected as the IPM for predicting the current CU to the one least likely to be selected for predicting the current CU. Redundancy in the list of MPMs may be removed, e.g., such that a MPM list may not include multiple identical IPM indices.

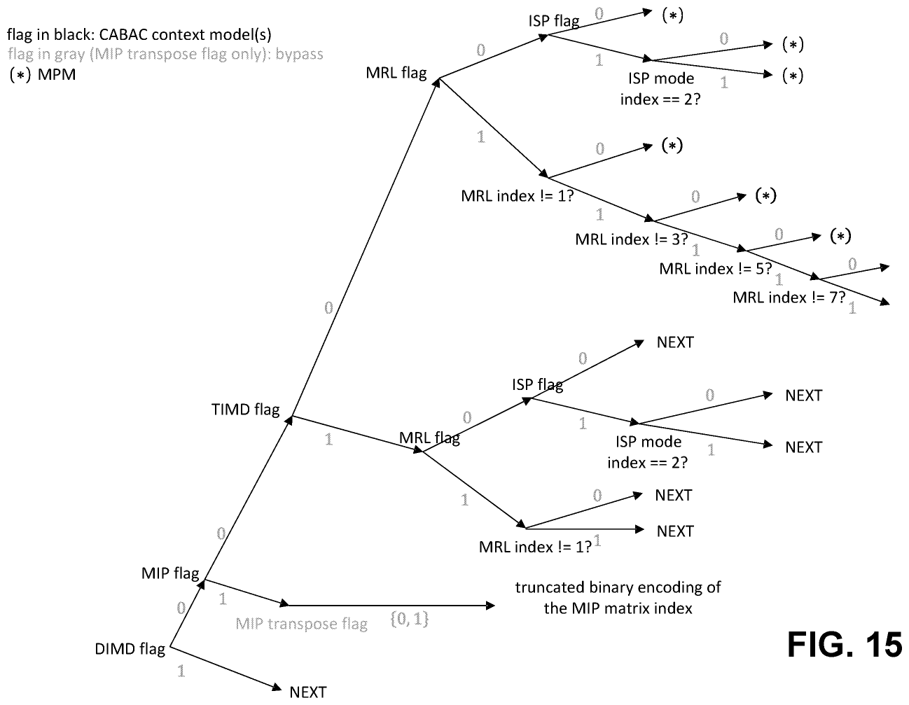

FIG. 15 shows an example of the signaling of the intra prediction mode selected to predict the current CU on the encoder side. In examples, the signaling of the intra prediction mode selected to predict the current CU on the encoder side may apply on the decoder side.

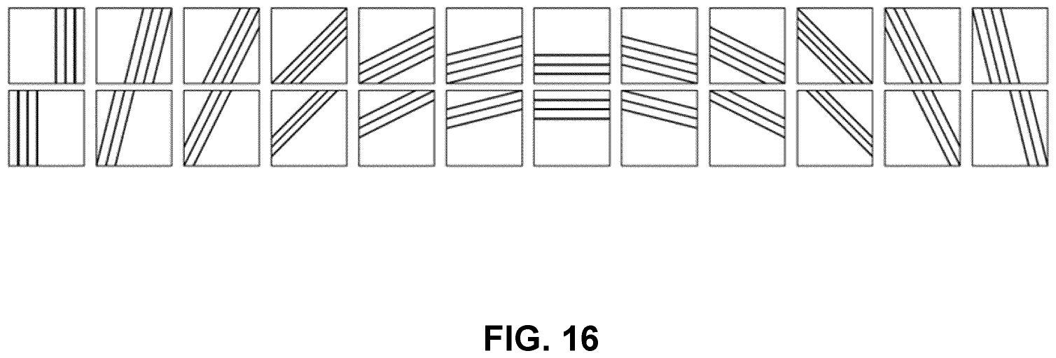

Geometric partition mode (GPM) may be used for better alignment of inter prediction boundary with objects. A GPM may include 64 partitions in total for inter prediction. In examples, if the geometric merge mode is used, a CU may be split into partitions (e.g., two partitions) by a geometrically located straight line (e.g., as shown in FIG. 16). FIG. 16 shows an example of 64 partitions for GPM. The location of the splitting line may be mathematically derived from the angle q; and distance offset ρᵢ of a specific partition. A partition in the CU may be inter-predicted using its motion parameters. Uni-prediction may be allowed for a partition. In examples, a partition may have a motion vector and a reference index. Based on predicting the partitions, the sample values along the splitting edge may be adjusted using a blending process with adaptive weights.

The blending weight for a position of the CU may be derived based on the distance between an individual position and the partition edge. The distance for a position (x, y) to the partition edge may be derived as follows:

$$d ( x , y ) = ( 2 x + 1 - w ) cos ( {φ}_{i} ) + ( 2 y + 1 - h ) sin ( {φ}_{i} ) - {ρ}_{i}$$

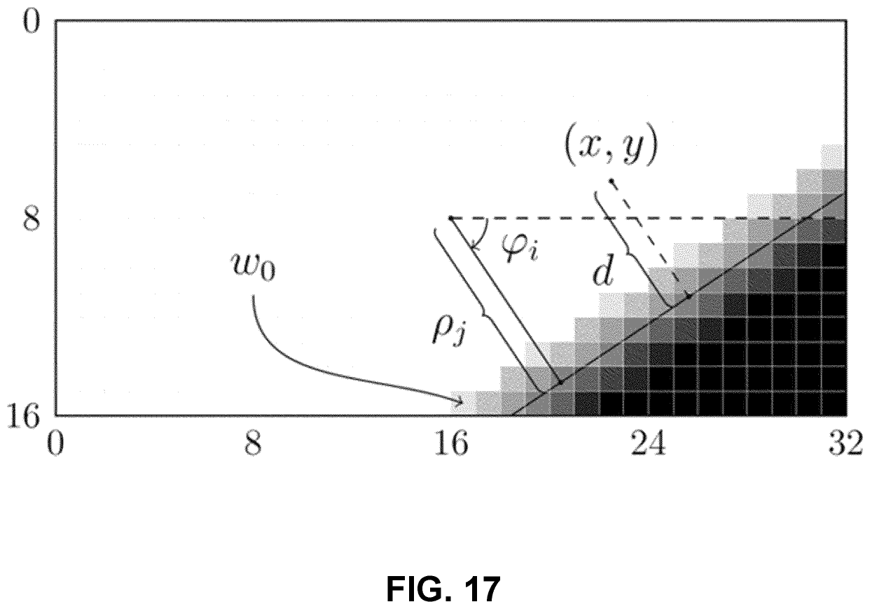

The weights for a part of a geometric partition may be derived as follows:

$$\begin{matrix}wIdxL ( x , y ) = partIdx ? 32 + d ( x , y ) : 32 - d ( x , y ) \\ {w}_{0} ( x , y ) = \frac{Clip 3 ( 0 , 8 , ( wIdxL ( x , y ) + 4 ) >> 3 )}{8} \\ {w}_{1} ( x , y ) = 1 - {w}_{0} ( x , y )\end{matrix}$$

where partIdx depends on the angle index i. FIG. 17 shows an example of weight w₀ in an example blending process.

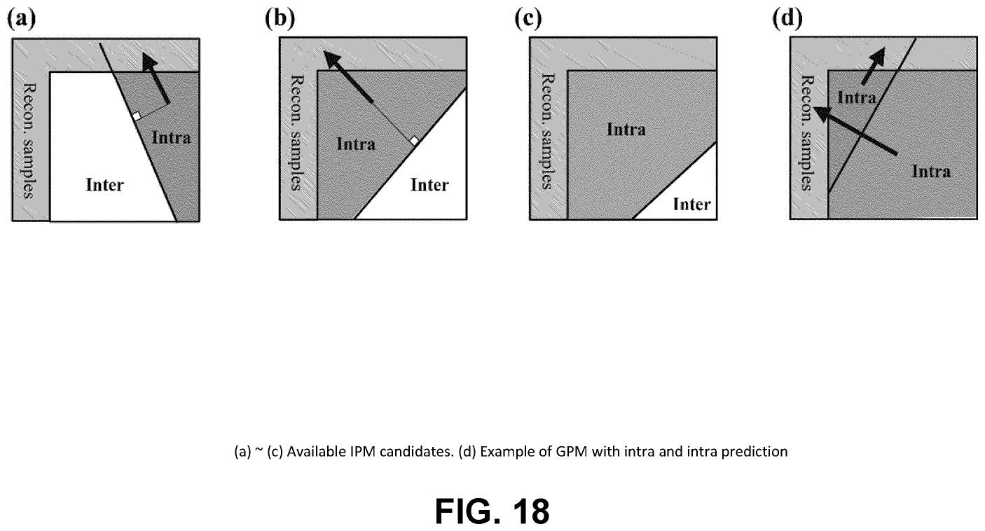

FIG. 18 shows an example of GPM intra mode. GPM intra mode may be associated with adding intra modes to GPM to combine an inter prediction with an intra prediction. In GPM with inter and intra prediction, the prediction samples (e.g., final prediction samples) may be generated by weighting inter predicted samples and intra predicted samples for a GPM-separated region. The inter predicted samples may be derived by the same scheme as the GPM, where the intra predicted samples may be derived by an IPM candidate list and an index signaled from the encoder. The IPM candidate list size may be pre-defined as 3. The available IPM candidates may be the parallel angular mode against the GPM block boundary (e.g., parallel mode), the perpendicular angular mode against the GPM block boundary (e.g., perpendicular mode), and the planar mode, as shown in FIG. 18.

GPM with intra and intra prediction, as shown FIG. 18, may be restricted to reduce the signaling overhead for IPMs and avoid an increase in the size of the intra prediction circuit on the hardware decoder.

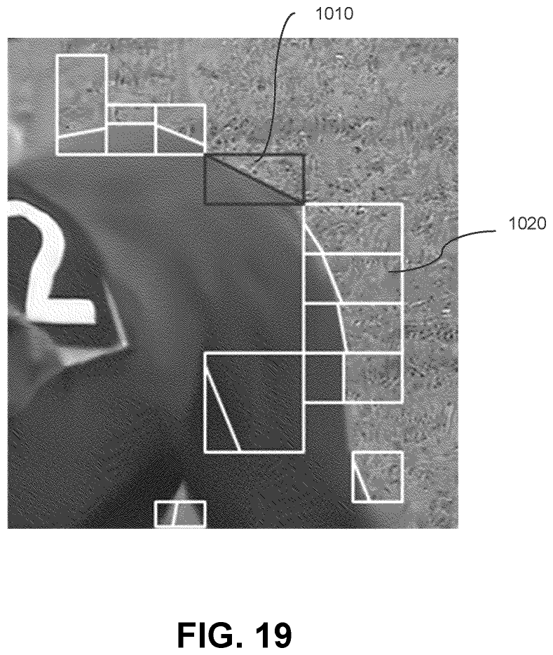

FIG. 19 shows an example of non-rectangular partitioning for a portion of a picture. Non-rectangular partitioning in in prediction (e.g., diagonal partitioning (1010) and general geometric partitioning (1020) may be used for outlining the shapes (e.g., that are complicatedly shaped) of objects from the background or other objects. Rectangular (e.g., including square) partitioning may be applied on intra frames, and the objects with different features may be contained inside an intra-coded block. In examples, if a block has a changing region along certain directions and a constant changing region at the same time, or if a block has more than one changing region along different directions, the changing regions may not be described by a single corresponding angular mode, by the PLANAR mode, or by the DC mode.

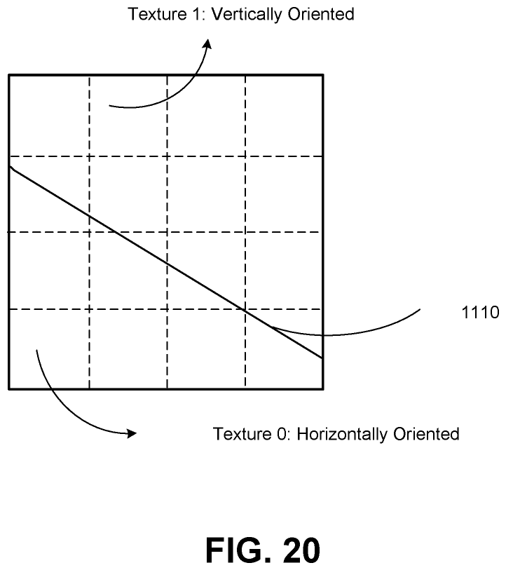

FIG. 20 shows an example of a piecewise smooth image model. In examples, if a piecewise-smooth image model is considered as shown in FIG. 20, where smooth regions (e.g., different smooth regions) with smoothness properties (e.g., different smoothness properties) are separated by an edge (1110), it may be less accurate to predict both regions with a single intra prediction model. In near-edge areas, the regions may be continually partitioned into smaller square/rectangular blocks and coded as smaller blocks separately. The smaller prediction blocks with similar data may result in overhead.

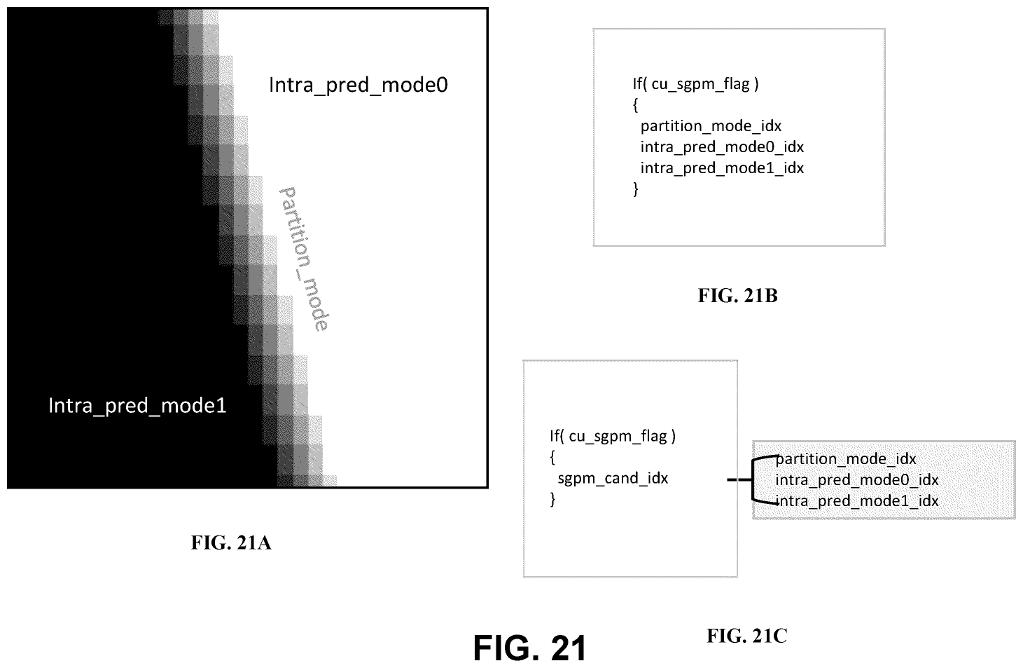

More than 2 IPMs for a CU may be supported (e.g., TIMD may support 2 IPMs; DIMD may support 3 IPMs). The blending process may be performed on one or more pixels with the same weights. To model such blocks, geometric partition modes for intra prediction may be considered. GPM may be extended to intra prediction, which may be referred to as spatial GPM (SGPM). FIG. 21A shows an example of SGPM. This may include a partition mode and associated IPMs (e.g., two associated IPMs). FIG. 21B shows an example of a partition mode and two IPMs associated with SGPM signaled in video bitstream. In examples, if these modes are signaled in the bitstream as shown in FIG. 21B, overhead bits may be yielded. To express the partition and prediction information efficiently in the bit-stream, a candidate list may be employed, and the candidate index may be signaled in the bitstream. A candidate in the list may derive a combination of a partition mode and intra prediction modes (e.g., two prediction modes), as shown in FIG. 21C.

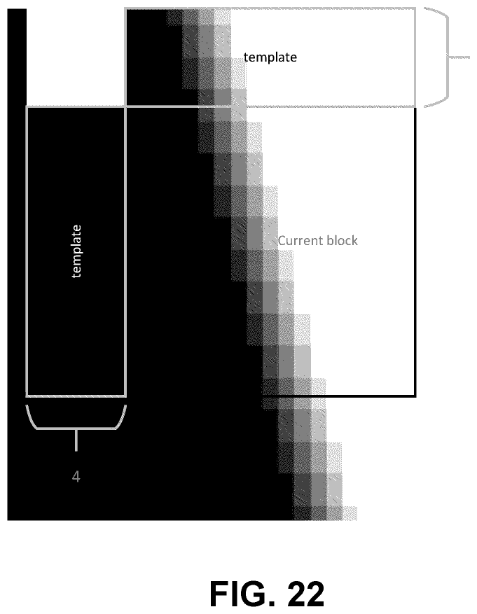

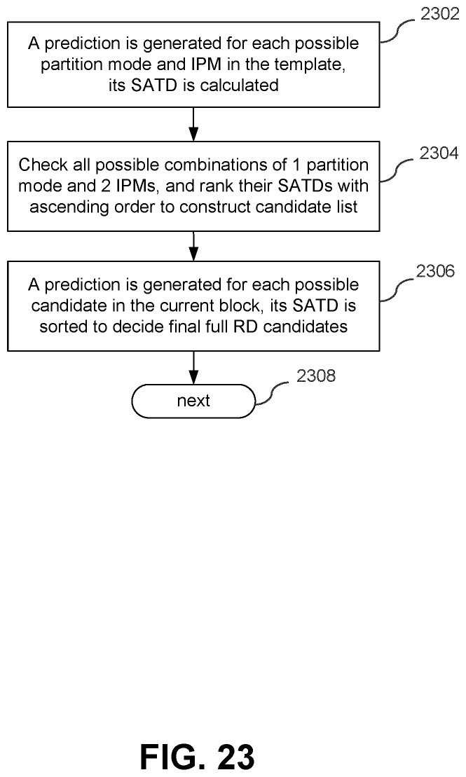

FIG. 21C shows a derived combination of a partition mode and two IPMs associated with SGPM signaled in video bitstream. A template may be used to generate the candidate list. The shape of the template may be the same as TIMD. For a possible combination of a partition mode and intra prediction modes (e.g., two intra prediction modes), a prediction may be generated for the template with the partitioning weight extended to the template, as shown in FIG. 22. FIG. 22 shows an example of a prediction generated for the template with the partitioning weight extended to the template. The combinations may be ranked in ascending order of their SATD between the prediction and reconstruction of the template. The length of the candidate list may be set equal to 16, and the candidates may be regarded as the most probable SGPM combinations of the current block. FIG. 23 shows an example of a flowchart of SGPM. The encoder and decoder may construct the same candidate list based on the template. At 2302, a prediction may be generated for a possible partition mode and Intra Prediction Mode (IPM) in the template, and an SATD may be calculated. At 2304, combinations of one partition mode and two IPMs may be checked, and SATDs of combinations may be ranked in ascending order to construct a candidate list. At 2306, a prediction for a possible candidate in the current block may be generated, and the SATD may be sorted to determine final full Rate-Distortion (RD) candidates. To reduce the complexity in building the candidate list, the number of possible partition modes and the number of possible intra prediction modes may be pruned. As described herein, 26 out of 64 partition modes may be used, and the MPMs out of 67 intra prediction modes may be used.

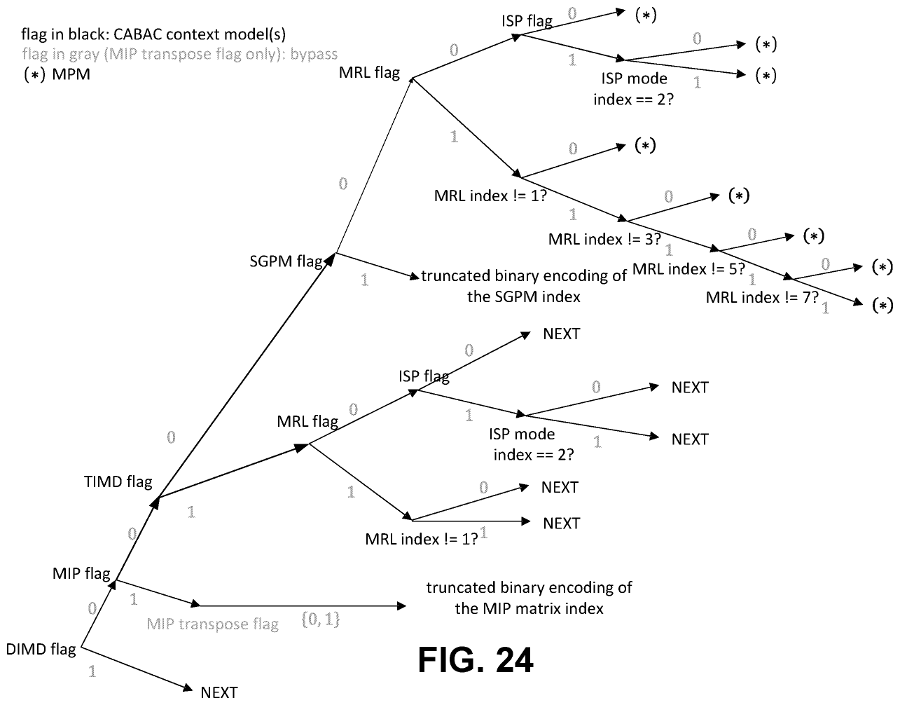

The SGPM may attempt to limit the possible partitions and IPMs. A trade-off may occur between complexity and performance (e.g., 0.26% gain for intra configuration (AI) with 172% encoding time and 114% decoding time increase). SGPM may be disabled, for example, if DIMD, TIMD, or MIP is used. MRL and ISP may be disabled, for example, if SGPM is used (e.g., as shown in FIG. 24). FIG. 24 shows an example of signaling the intra prediction mode selected to predict the current CU on the encoder side including adding SGPM.

One or more of the following may apply for SGPM: derivation of the intra prediction modes; selection of the partition modes; combination of the intra prediction modes and partition modes; template use for building the SGPM candidate list; length of the SGPM candidate list; and/or interactions between SGPM and other intra modes.

SGPM may include a partition mode and associated IPMs (e.g., two associated IPMs) for an intra coded block. The SGPM mode may interact with other intra modes, such as DIMD, TIMD, ISP, and/or the like.

Intra prediction modes may be used for building the candidate list. To reduce the complexity in building the candidate list, the number of possible intra prediction modes may be pruned. In examples, the MPMs out of 67 intra prediction modes may be used. MPMs associated with a coding block may be obtained. Predictions of a first template that correspond to the MPMs may be determined. A first candidate Intra Prediction Mode (IPM) may be selected from the MPMs. The selection may be based on a comparison of the first template to the predictions that correspond to the MPMs. The prediction modes may be derived based on template matching, motion estimation, or pattern recognition. Inter mode prediction may be used. The most probable motion vectors for a block in a current frame may be selected, using MPMs. The selection may be determined from a comparison of the coding block against the corresponding predictions for an MPM.

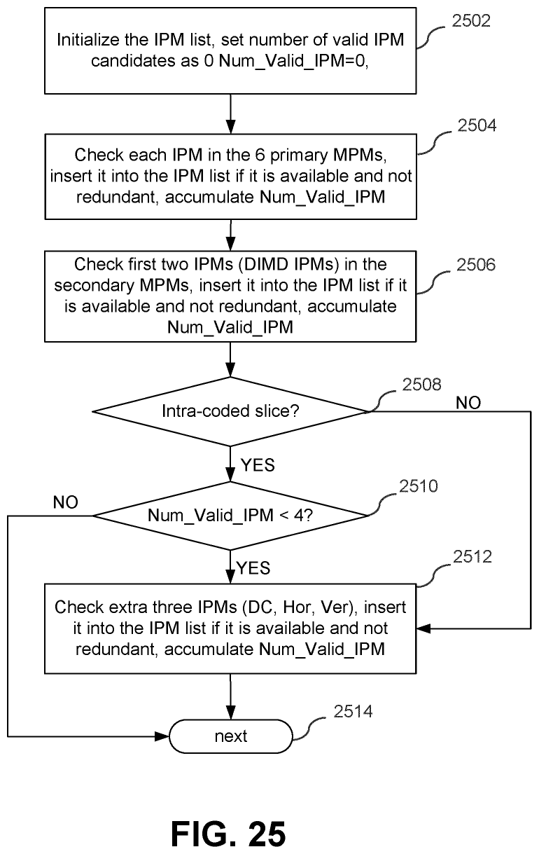

FIG. 25 shows an example of the derivation of the possible IPM candidates for SGPM. At 3001, an IPM list may be initialized. The available primary MPMs (e.g., at 2504, 6 primary MPMs such as PLANAR, IPM of left/above/below-left/above-right/above-left blocks) and DIMD IPMs (e.g., at 2506, 2 DIMD IPMs) may be included in the list of the possible intra prediction modes. At 2508, for an intra-coded slice (e.g., I slice), extra IPMs (e.g., DC, horizontal, and/or vertical) may be inserted (e.g., continually inserted) in the list. In examples, at 2510, if the size of current possible IPMs does not reach 4, it may be indicated that up to 8 IPM candidates may be added to the list for intra-coded slice. Otherwise, at 2512, the 3 extra IPMs may be inserted (e.g., continually inserted) in the list, which may indicate that up to 11 IPM candidates may be added to the list for inter-coded slice (e.g., B/P slice). In examples, if inserting an IPM candidate to the list, a redundancy check may be applied to find whether there is an identical IPM already in the list. In examples, for I slice, the possible IPM candidates may reach 8. 2 out of 8 IPM candidates may be selected for SGPM, which means 2×8×Num_{PartitionMode} predictions may be generated, and the related template SATD costs may be calculated. 8× 7× Num_{PartitionMode} comparisons may be checked.

The possible IPM candidates for SGPM may be derived based on an IPM list size that may be dynamically changed. In examples, to reduce the complexity, the maximally allowed IPM list size may be set as M (M<8). In examples, M may be 4. If the total number of available IPM candidates reaches M, the IPM candidate list construction process for SGPM may be terminated.

In examples, the allowed IPM list size (e.g., maximally allowed IPM list size) may depend on the frame resolution, slice type, the block size, and/or block shape. For frame resolution, a larger IPM list size may be applied for larger resolution contents (e.g., 4K contents), for example, to find optimal IPMs. For the slice type, a smaller (e.g., or larger) IPM list size may be applied for inter-coded slice. In examples, if it is a B slice, the corresponding IPM list size may be set as M=2. The block size (e.g., width and/or height of the current block) may satisfy (e.g., is less than, is greater than, is equal to, etc.) a specific number. In such a case, a smaller (e.g., or larger) IPM list size may be applied for this block. In examples, if the block size is smaller than 8×8, the corresponding IPM list size may be set as M=2, and the number of pixels (e.g., small number of pixels) to be predicted may not justify the searching cost of the granularity (e.g., additional granularity).

The IPM candidate list may be constructed by including one or more of the following possible types of IPM candidates: PLANAR; DIMD IPMs (e.g., 2 DIMD IPMs); TIMD IPMs (e.g., 2 TIMD IPMs); DC; or horizontal (e.g., IPM=18), vertical (e.g., IPM=50), diagonal (e.g., IPM=34), and/or antidiagonal (e.g., IPM=66).

If the M-length IPM list is not full based on IPM candidates described herein being added, the IPM from a list of primary MPMs (e.g., 6 primary MPMs) and a list of secondary MPMs (e.g., 16 secondary MPMs) may be inserted, for example, at the end until the IPM candidate number (e.g., maximum IPM candidate) is encountered.

In examples, the selected intra modes may include intra modes orthogonal to the derived TIMD and/or DIMD IPMs. The modes may include those that are found 45 degrees before/after the DIMD and/or TIMD modes.

The order of the IPM candidates described herein to be added into the list may depend on the slice type, the block size, and/or the block shape. The IPM candidates described herein may be replaced by other available IPM candidates, for example, the available IPM from above/left/below-left/above-right/above-left neighboring blocks. The replacement may depend on the slice type, the block size, and/or the block shape. In examples, if the current slice is an inter-coded slice (e.g., B slice), the order of adding IPM candidates may be replaced, such that DC may be inserted into the IPM list (e.g., first). In examples, the block shape (e.g., the ratio of width (w) to height (h) of the current block) may satisfy (e.g., is less than, is greater than, is equal to, etc.) a specific number and the order of adding IPM candidates, or possible IPM candidates, may be replaced. In examples, if the aspect ratio of a block is

$$\frac{W}{H} \geq 4 ,$$

the available IPM from above/above-right/above-left may be inserted into the IPM list (e.g., first).

In examples, a DIMD and/or TIMD process may be invoked on the above or left templates (e.g., separately). An intra mode may be derived from the above template (e.g., which may be vertically oriented) using TIMD and/or DIMD, and another intra mode may be derived from the left template (e.g., which may be horizontally oriented). The intra modes may be added to the candidate list. The intra modes may be considered as the possible modes of the candidate list.

Partition modes (e.g., possible partition modes) may be used for building the candidate list. To reduce the complexity in building the candidate list, the number of possible partition modes may be pruned. In examples, 26 out of 64 partition modes may be used.

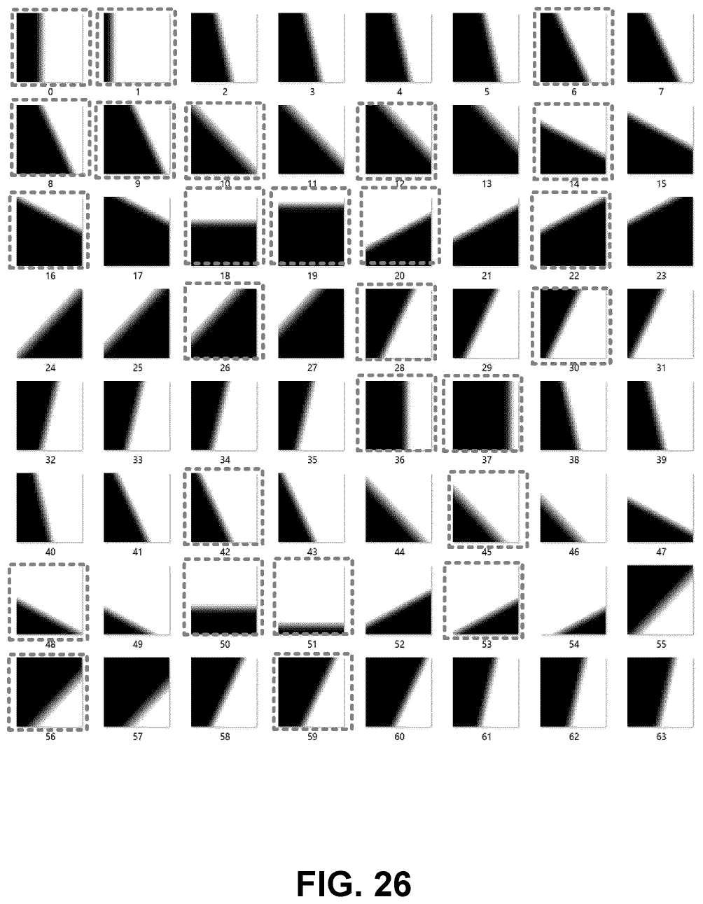

FIG. 26 shows an example of the selected possible partition mode candidates for SGPM. The candidates may be marked in the gray dash box as shown in FIG. 26. For 26 partition modes, there may be 2× Num_{IPM}×26 predictions generated, and the related template SATD cost may be calculated. Num_{IPM}×(Num_{IPM}−1)×26 comparisons may be checked.

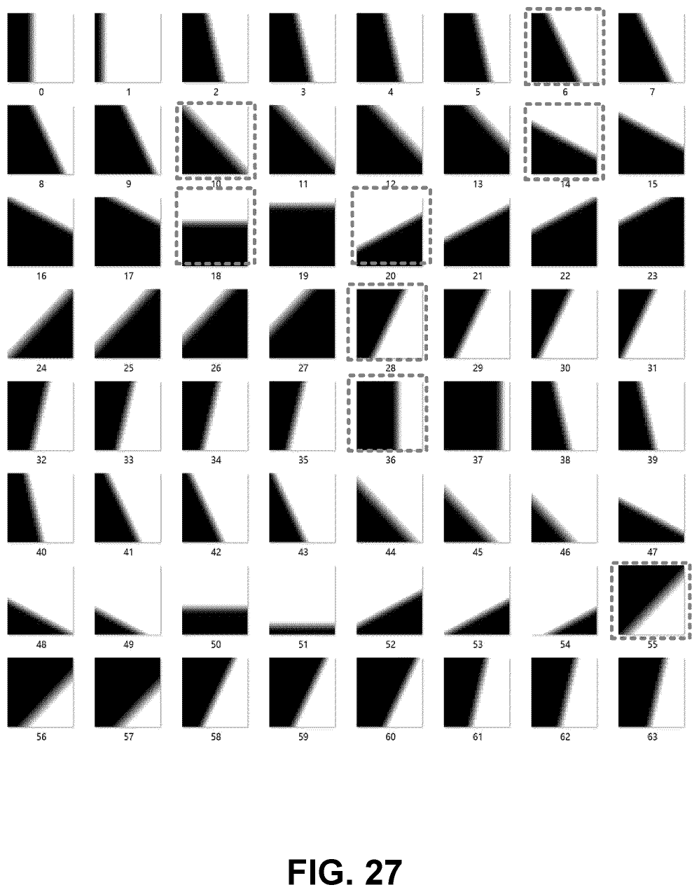

Possible partition mode candidates for SGPM may be selected. In examples, to further reduce the complexity, the allowed partition mode list size (e.g., maximally allowed partition mode list size) may be set as N (N<26) (e.g., N may be 8). FIG. 27 shows an example of reduced selected partition mode candidates for SGPM. The block may be divided into two sub-partitions, e.g., evenly, with the selection of partitions modes.

In examples, the allowed partition mode list size (e.g., maximally allowed partition model list size) may depend on the frame resolution, slice type, the block size, and/or the block shape. For the slice type, a smaller list size of partition modes may be applied for an inter-coded slice. In examples, the slice type may be a B slice, and the corresponding list size of partition mode may be set as N=4, where diagonal split (e.g., such as partition mode 10 as shown in FIG. 27), horizontal split (e.g., partition mode 18 as shown in FIG. 27), vertical split (partition mode 36 as shown in FIG. 27), and/or antidiagonal split (e.g., partition mode 55 as shown in FIG. 27) are allowed. The block size (e.g., width and/or height of the current block) may satisfy (e.g., is less than, is greater than, is equal to, etc.) a specific number. A smaller (e.g., or larger) list size of partition modes may be applied for the block. In examples, if the block size is smaller than 8×8, the corresponding list size of partition modes may be set as N=1, where diagonal split (e.g., partition mode 10 in FIG. 27) is allowed.

In examples, a syntax element may be signaled to indicate the partitioning applied at the encoder side. The partitioning may be a correction of the derived split line from the template analysis. A value of delta angular degree I may be signaled, where I may be 1, 2, etc. that shifts the partitioning (e.g., best partitioning) from the template analysis by +/−I degrees to obtain the applied partitioning.

The selection of partition mode candidates may depend on the block shape. The block shape (e.g., the ratio of width to height of the current block) may satisfy (e.g., is less than, is greater than, is equal to, etc.) a specific number. The different set of selected partition modes may be applied for the block. In examples, if the aspect ratio of a block is

$$\frac{W}{H} \geq 4 ,$$

the corresponding set of partition mode candidates may include one or more partition modes, which may result in the sub-partition being adjacent to an above boundary having a larger surface, such as the partition modes 40, 42, 43, 45, 46, 47, 48, 49, 50, 51, 52, 53, and 54 in FIG. 27.

Combinations (e.g., possible combinations) may be used for building the candidate list. For a possible combination of a partition mode and intra prediction modes (e.g., two intra prediction modes), a prediction may be generated for the template with the partitioning weight extended to the template. The combinations may be ranked in ascending order of their SATD between the prediction and reconstruction of the template.

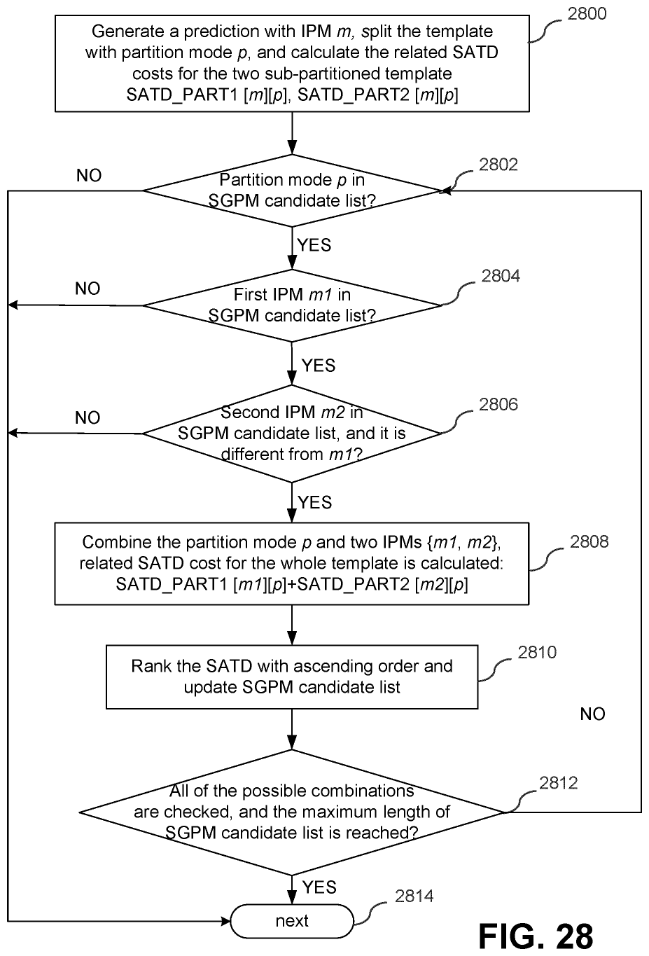

FIG. 28 is an example flowchart for checking and sorting possible combinations to derive the SGPM candidate list. It may be determined that an SGPM is used for the coding block. A first template and a second template of the coding block for IPM derivation may be obtained based on determining that SGPM is used for the coding block. In some examples, the first template and the second template of the coding block for inter prediction mode derivation may be obtained. The second template may be different from the first template. A third template that may include the first and second template may be obtained. Candidates in an SGPM list associated with the coding block may be ranked based on the third template of the coding block. For example, the candidate combinations in the SGPM list may be ranked in ascending order of their respective SATD between the prediction and reconstruction of the third template.

At 2800, a prediction may be generated with an IPM. The template may be partitioned according to the partition mode, and the SATD costs for two sub-partitioned templates, SATD_PART1 [m][p] and SATD_PART2 [m][p], may be calculated. At 2802, if the partition mode is in the SGPM candidate list, it may be determined whether the first IPM m1 is present in the SGPM candidate list at 2804. At 2806, a second IPM m2 in the SGPM candidate list is identified, and it may be determined whether m2 is different from m1.

In 2808, the two IPMs {m1, m2} may be combined with the partition mode ‘p’, and the SATD cost for the whole template may be calculated. At 2810, the calculated SATD costs may be ranked in ascending order, and SGPM candidate list may be updated. At 2812, possible combinations may be checked, and the maximum length of the SGPM candidate list may be reached.

As shown in FIG. 28, there may be Num_{IPM}×(Num_{IPM}−1)×Num_{PartitionMode} comparisons. In examples, for I slice the possible IPM candidates may reach 8, and the possible partition modes may be 26, which means 8×7×26=1456 comparisons. The search to identify 16 candidates may increase the encoding and decoding times. The number of combinations of partition and prediction modes may be reduced.

Combination restrictions on the possible partition and prediction mode candidates for building the SGPM candidate list may be described herein. In examples, to reduce the complexity after one specific partition mode is selected, one or more IPM candidates may be allowed for the combination based on the selected partition mode. In examples, the IPM candidate list size may be pre-defined as 3. A first candidate intra prediction mode (IPM) may be derived based on a first template of a coding block. A second candidate IPM may be derived based on a second template of the coding block. The coding block may be decoded based on the first candidate IPM and the second candidate IPM. A third candidate IPM may be selected based on a partition mode of the coding block. The first candidate IPM, the second candidate IPM, and the third candidate IPM may be added to an IPM candidate list associated with the coding block. The coding block may be decoded based on the IPM candidate list. Inter prediction mode may use the templates to derive distinct inter prediction candidate modes and decode the coding block based on the inter prediction candidate modes.

The available IPM candidates may be the parallel angular mode against the splitting boundary (e.g., parallel mode), the perpendicular angular mode against the splitting boundary (e.g., perpendicular mode), and/or the planar mode. In examples, if a horizontal split (e.g., partition mode 18 as shown in FIG. 27) is selected, the horizontal mode (e.g., the parallel mode), vertical mode (e.g., the perpendicular mode), and planar mode may be allowed for the combination.

The IPM candidate list size may be reduced to 2. In examples, a first candidate IPM and a second candidate IPM may be added to an IPM candidate list associated with the coding block. The coding block may be encoded and/or decoded based on the IPM candidate list. The available IPM candidates may be the parallel angular mode against the splitting boundary (e.g., parallel mode) and the planar mode.

The available IPM candidates may be parallel angular mode against the splitting boundary and its closet angular mode(s). In examples, the available IPM candidates may be the perpendicular angular mode against the splitting boundary and its closet angular mode(s).

The available IPM candidates for one or more sub-partitions may be affected depending on the selected partition mode candidate and the position of the sub-partition. In examples, the diagonal split (e.g., partition mode 10 as shown in FIG. 27) may be selected. The IPM candidates in the horizontal direction may be allowed for the sub-partition adjacent to the left boundary. The IPM candidates in the vertical direction may be allowed for another sub-partition adjacent to the above boundary.

For an IPM (e.g., a first IPM), one or more IPM candidates may be allowed as the second IPM for the combination.

The possible second IPM candidates may be the closer angular modes to the IPM (e.g., first IPM), which means the absolute difference of these IPM indices (e.g., two IPM indices) may be less than a number (e.g., threshold T). The value of this threshold T may be pre-defined and fixed for sequences or may be signaled in sequence parameter set (SPS), view parameter set (VPS), picture parameter set (PPS), and/or picture header, or may be derived based on the block size. In examples, if a horizontal mode (e.g., IPM=18) is selected as the IPM (e.g., first IPM), angular modes with IPM indices that are in range of (18−T, 18+T) may be allowed to be the possible second IPM candidates.

The possible second IPM candidates may be the perpendicular angular modes against the first IPM, which means the absolute difference of these IPM indices (e.g., two IPM indices) may be larger than a number. In examples, if a horizontal mode (e.g., IPM=18) is selected as the first IPM, a vertical mode (e.g., such as IPM=50) may be allowed to be the possible second IPM candidate.

A template may be used to generate the candidate list. The shape of the template may be the same as TIMD, which may include 4 above neighboring rows and 4 left neighboring columns of the current block, as shown in FIG. 22. There may be 2×Num_{IPM}×Num_{PartitionMode} predictions that are generated for the template and the related SATD cost may be calculated for sorting the SGPM candidate. The design of the template may impact the trade-off between the complexity and the performance. In examples, the larger the size of template is, the higher computational complexity the encoder/decoder may have (e.g., memory may be used to access the neighboring samples). The larger the size the template is, the more accurate estimation and selection of a partition and prediction mode may be.

Templates for building the SGPM candidate list may be obtained. In examples, the template size may depend on the frame resolution, the slice type, the block size, and/or block shape. In examples, the block size (e.g., width and/or height of the current block) may satisfy (e.g., is less than, is greater than, is equal to, etc.) a number. In examples, the template size may be set equal to 1. The height of an upper (e.g., top) template may be 1, and the width of the left template may be 1. The left template may be obtained as a first template, and the top template may be obtained as the second template. A smaller (e.g., or larger) template size may be applied for this block. To improve the accuracy of estimation and selection, if the block size is smaller than 8×8, the corresponding template may include one above neighboring row and one left neighboring column of the current block. In examples, if the block size is larger than 16×16, the corresponding template may include the whole above neighboring block and the whole left neighboring block of the current block. To reduce the complexity of computation and memory access, the smaller block may use a larger template and vice versa. For frame resolution, a larger template size may be applied for larger resolution contents (e.g., 4K contents) to find an SGPM candidate. For the slice type, a smaller (or larger) template size may be applied for an inter-coded slice. In examples, if the slice is a B slice, the corresponding template size may include one above neighboring row and one left neighboring column of the current block set as M=2.

The template may depend on the selected partition mode candidate and/or the position of the sub-partition. In examples, a first and second template of the coding block may be determined. The first and second coding blocks may be determined based on a partition mode associated with the coding block. The coding block may include a first partition and a second partition. The first template of the coding block may be determined based on the first partition. The first partition of the coding block may be encoded and/or decoded based on the first candidate IPM derived based on the first template. The second template of the coding block may be determined based on the second partition. The second partition of the coding block may be encoded and/or decoded based on the second candidate IPM derived based on the second template. Inter prediction mode may be integrated where first and second templates, based on respective partitions of the coding block, may be determined. The respective partitions may be encoded and/or decoded based on the derived inter prediction modes.

As described herein, if the diagonal split (e.g., partition mode 10 as shown in FIG. 27) is selected, the IPM candidates in horizontal direction may be allowed for the sub-partition adjacent to the left boundary and the IPM candidates in the vertical direction may be allowed for another sub-partition adjacent to the above boundary. In examples, the left template may be applied to derive the horizonal directional modes, and the above template may be applied to derive the vertical directional modes.

In examples, a possible candidate list length may be static. A candidate list may be employed, and the candidate index may be signaled in video data. A candidate in the list may be a combination of a partition mode and intra prediction modes (e.g., two intra prediction modes). In examples, an IPM candidate list associated with a coding block may be generated based on a first candidate IPM and a second candidate IPM. A first prediction mode for a first partition and a second prediction mode for a second partition may be based on an SGPM index and the IPM candidate list.

The length of the candidate list may be set equal to 16, and the candidates may be regarded as the most probable SGPM combinations for the current block. Full radio distortion optimization (RDO) may be performed on the 16 candidates. The encoding time may increase. An SGPM index may use truncated binary coding, and a bin length of the SGPM index may be dependent on the length of SGPM candidate list. A 16-length candidate list may yield significant coding bits.

In examples, the length of the possible SGPM candidates may be dynamically determined. To reduce the complexity and bits cost, the length of the SGPM candidate list may be set as L (L<16), and the candidate list length may depend on the frame resolution, slice type, and/or the block size. For the slice type, a smaller (or larger) length of SGPM candidate list may be applied for inter-coded slice. In examples, if it is a B slice, the corresponding length of the SGPM candidate list may be set as L=4. The block size (e.g., width and/or height of the current block) may satisfy (e.g., is less than, is greater than, is equal to, etc.) a number. In such a case, a smaller (or larger) length of the SGPM candidate list may be applied for this block. In examples, if the block size is smaller than 8×8, the corresponding length of the SGPM candidate list may be set as L=2. The small number of pixels to be predicted may not justify the searching cost of the granularity.

In examples, based on applying full RDO on the candidates (e.g., these 16 candidates), an SATD check may be applied (e.g., first applied) to sort the most probable candidate(s) (e.g., one or two candidates) among these 16 candidates in terms of the smallest SATD cost. The retained candidate(s) (e.g., the retained one or two candidates) may perform full RDO. The RDO candidate list length (e.g., final RDO candidate list length) may depend on the frame resolution, slice type, and/or the block size.

In examples, before applying the full RDO on the candidates, an SATD check may be applied (e.g., first applied) to sort these candidates. The full RDO process may be performed for the candidates having a SATD cost lower than (e.g., lower than or equal to) an amount of the one (e.g., best one, such as the smallest one). In examples, candidates having a SATD cost lower than 1.5 times the minimum SATD cost may be processed in the full RDO.

Interaction between SGPM, DIMD, and/or TIMD may be provided. The SGPM may be disabled, for example, if DIMD and/or TIMD is used (e.g., as shown in FIG. 24). The interaction between SGPM, DIMD, and/or TIMD may be described herein.

In examples, SGPM may be tested if DIMD is enabled. As described herein, DIMD IPMs (e.g., two best DIMD IPMs) may be derived from the HOG. The predictors (e.g., two predictors) may be combined with the planar mode predictor with the weights derived from the HOG. The blended predictor PredDIMD and the related RDO cost Cost_{DIMD} may be stored. The DIMD IPMs (e.g., two best DIMS IPMs) may be reused as the possible intra prediction modes (e.g., two possible intra prediction modes) for SGPM. 26 out of 64 partition modes may be used (or possible partition modes described herein) for combinations with the DIMD IPMs. The candidate list construction may be similar to techniques described herein. Based on obtaining the smallest RDO cost from the SGPM candidate list Cost_{DIMD_SGPM} and the related blended predictor Pred DIMD_SGPM, the comparison with Cost DIMD may be performed. A flag dimd_sgpm_flag indicating whether a SGPM mode is to be applied on top of DIMD mode may be signaled. On a condition that Cost_{DIMD_SGPM}<Cost_{DIMD} is true, dimd_sgpm_flag may be set as true, one additional index dimd_sgpm_index may be signaled, and the blended predictor (e.g., final blended predictor) may be replaced as Pred DIMD_SGPM.

In examples, SGPM may be tested if TIMD is enabled. Described herein, IPMs (e.g., the first two IPMs) involving the MPM list with the minimum SATD between the prediction and reconstruction samples of the template may be retained in the pass (e.g., first pass). For these modes (e.g., two modes), if the IPM is neither PLANAR nor DC, TIMD may test in terms of prediction SATD its closest extended directional IPMs (e.g., two closest extended direction IPMs). On a condition that SATD_{IPM2}<2*SATD_{IPM1} is true, the selected IPMs (e.g., final two selected IPMs) may be fused with the weights, which may depend on the SATDs of the IPMs (e.g., two IPMs). The blended predictor Pred_{TIMD} and the related RDO cost Cost_{TIMD} may be stored. The TIMD IPMs (e.g., two best TIMD IPMs) may be reused as the intra prediction modes for SGPM. 26 out of 64 partition modes may be used (or possible partition modes described herein) for combinations with these TIMD IPMs (e.g., two best TIMD IPMs). The candidate list construction may be similar to techniques described herein. Based on obtaining the smallest RDO cost from the SGPM candidate list Cost_{TIMD_SGPM} and the related blended predictor Pred_{TIMD_SGPM}, the comparison with Cost_{TIMD} may be performed. A flag timd_sgpm_flag indicating whether a SGPM mode is to be applied on top of TIMD mode may be signaled. On a condition that Cost_{TIMD_SGPM}<Cost_{TIMD} is true, timd_sgpm_flag may be set as true, one additional index timd_sgpm_index may be signaled, and the blended predictor (e.g., final blended predictor) may be replaced as Pred_{TIMD_SGPM}. In examples, if SATD_{IPM2}≥2*SATD_{IPM1} is true, the first IPM may be used and SGPM mode may not apply.

Interaction between SGPM and ISP may be provided. ISP may be disabled, for example, if the SGPM is used (e.g., as shown in FIG. 24). In examples, ISP may be tested if SGPM is enabled. As described herein, the luma intra-predicted blocks may be vertically or horizontally divided into 2 or 4 sub-partitions depending on the block size. The reconstructed sample values of a sub-partition may be available to generate the prediction of the next sub-partition. Based on different IPMs (e.g., two different IPMs) being applied on the sub-partitions (e.g., two sub-partitions) of SGPM respectively, ISP may be allowed, for example, if partition modes (e.g., specific partition modes) of SGPM are selected. If partition modes that are partitioned vertically (e.g., such as the partition modes 0/1/36/37 in FIG. 27) and horizontally (e.g., such as the partition modes 18/19/50/51 in FIG. 27) are selected for SGPM, ISP may be allowed.

The split direction of ISP may depend on the partition modes of SGPM. In examples, if SGPM is used to split the current block vertically, left and right sub-partitions may apply different IPMs (e.g., two different IPMs). In examples, if the ISP is used to split the block vertically, the right sub-partition may not benefit from making use of the available reconstructed samples in the left sub-partition due to their different IPMs. The split direction of ISP may be perpendicular against the splitting boundary of the SGPM. If one of the SGPM vertical partition modes is selected, the block may be horizontally divided into 2 or 4 sub-partitions depending on the block size, and vice versa. Signaling of syntax isp_mode, which specifies the split vertically or horizontally, may be skipped.

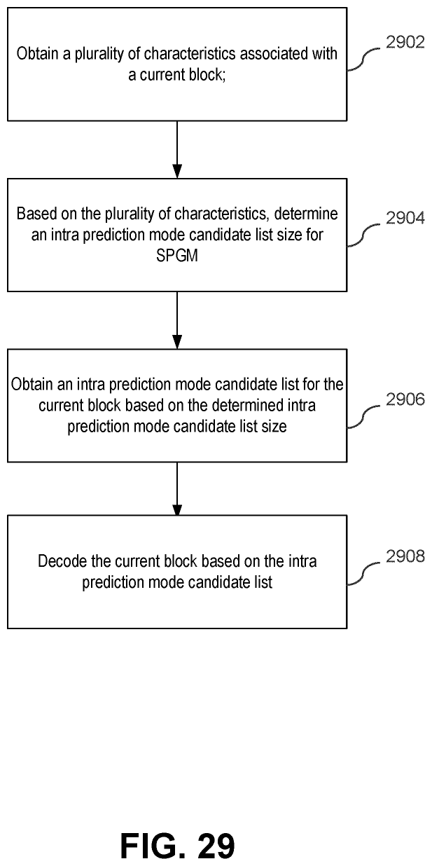

FIG. 29 is an example flowchart of determining an IPM candidate list size based on characteristics (e.g., on decoder side).

In examples, characteristics may be obtained. The characteristics may be associated with a current block. The characteristics may include one or more of the following: frame resolution, slice type, block size, and/or block shape. In examples, the frame resolution may be 4k. The slice type may be an intra coded slice, such as an I slice. The slice type may be an inter coded slice, such as a B slice. The block size may be associated with a width (w) and a height (h). In examples, the block size may be 8×8.

Based on one or more of the plurality of characteristics (e.g., frame resolution, slice type, block size, and/or block shape), an intra prediction mode candidate list size may be determined for SGPM associated with the current block. In examples, the list size may be set to 3 if the slice type is an intra coded slice and/or if the frame resolution is in 4k. The list size may be set to 2 if the block size is 8×8 or smaller than 8×8. An intra prediction mode candidate list may be obtained for the current block based on the determined intra prediction mode candidate list size. In examples, obtaining the list may include checking whether a potential IPM candidate is already in the list (e.g., redundancy check) and whether adding the potential candidate would result in the list exceeding its determined candidate list size (e.g., using NUM_VALID_IPM as described herein).

In examples, based on one or more of the plurality of characteristics, an SGPM candidate list size associated with the current block may be determined. An SGPM candidate list associated with the current block may be obtained based on the determined SGPM candidate list size. The current block may be decoded based on the SGPM candidate list. The characteristics may include one or more of the following: frame resolution, slice type, block size, or block shape.

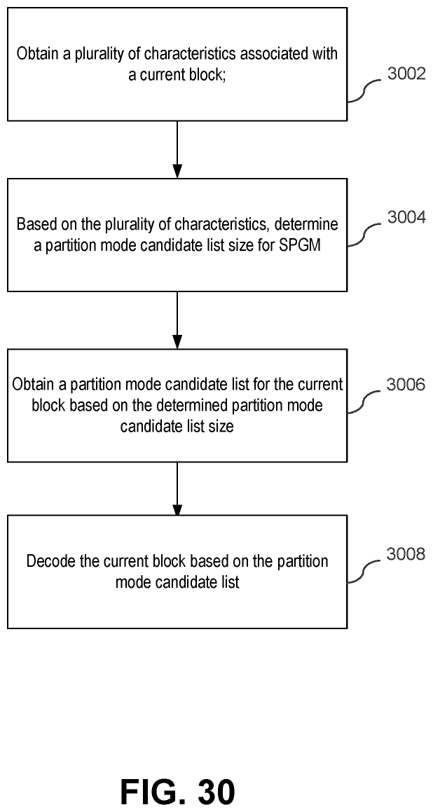

FIG. 30 is an example flowchart of determining a partition candidate list size based on characteristics (e.g., on the decoder side).

In examples, at 3002, one or more characteristics may be obtained. The characteristics may be associated with a current block. The characteristics may include one or more of the following: frame resolution, slice type, block size, and/or block shape. In examples, the frame resolution may be 4k. The slice type may be an intra coded slice, such as an I slice. The slice type may be an inter coded slice, such as a B slice. The block size may be associated with a width (w) and a height (h). In examples, the block size may be 8×8.

At 3004, based on one or more of the plurality of characteristics (e.g., frame resolution, slice type, block size, and/or block shape), a partition mode candidate list size may be determined for SGPM associated with the current block. At 3006, a partition mode candidate list may be obtained for the current block based on the determined partition mode candidate list size. At 3008, the current block may be decoded based on the partition mode candidate list.

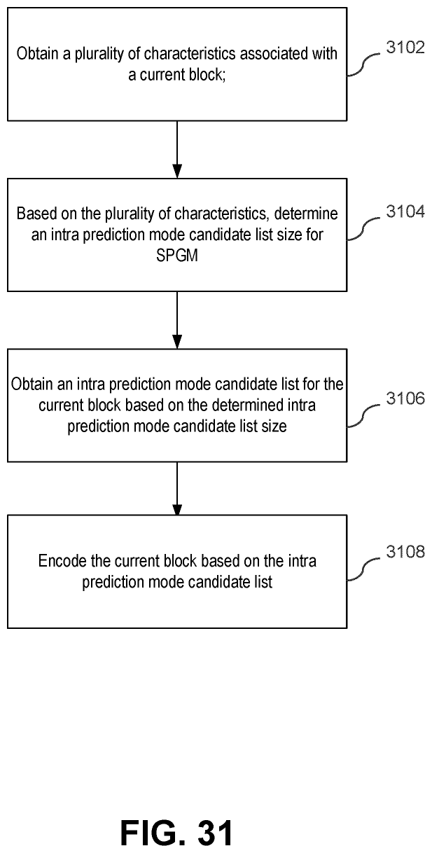

FIG. 31 is an example flowchart of determining an IPM candidate list size based on characteristics (e.g., on the encoder side).

In examples, at 3102, characteristics may be obtained. The characteristics may be associated with a current block. The characteristics may include one or more of the following: frame resolution, slice type, block size, and/or block shape. In examples, the frame resolution may be 4k. The slice type may be an intra coded slice such, as an I slice. The slice type may be an inter coded slice, such as a B slice. The block size may be associated with a width (w) and a height (h). In examples, the block size may be 8×8.

Based on one or more of the plurality of characteristics (e.g., frame resolution, slice type, block size, and/or block shape), at 3104, an intra prediction mode candidate list size may be determined for SGPM associated with the current block. In examples, the list size may be set to 3 if the slice type is an intra coded slice and/or if the frame resolution is in 4k. The list size may be set to 2 if the block size is 8×8 or smaller than 8×8. At 3106, an intra prediction mode candidate list may be obtained for the current block based on the determined intra prediction mode candidate list size. In examples, the generation may include checking whether a potential IPM candidate is already in the list (e.g., redundancy check) and whether adding the potential candidate would result in the list exceeding its determined candidate list size (e.g., using NUM_VALID_IPM as described herein).

In examples, based on one or more of the plurality of characteristics, a SGPM candidate list size associated with the current block may be determined. An SGPM candidate list associated with the current block may be obtained based on the determined SGPM candidate list size. At 3108, the current block may be encoded based on the SGPM candidate list. The characteristics may include one or more of the following: frame resolution, slice type, block size, or block shape.

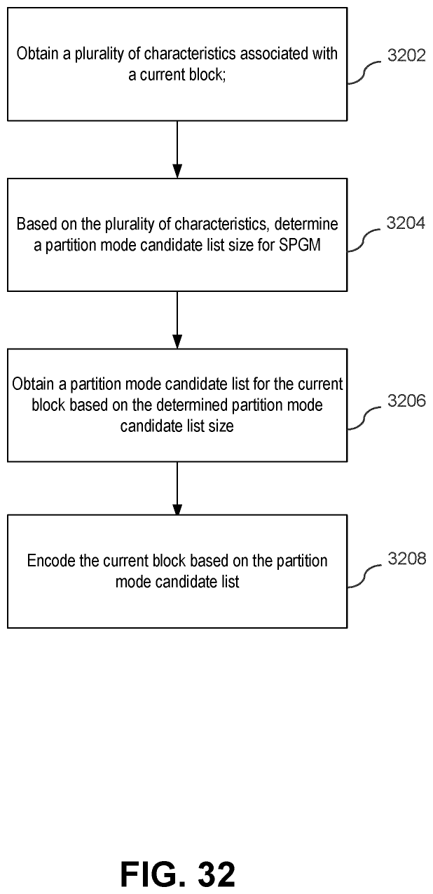

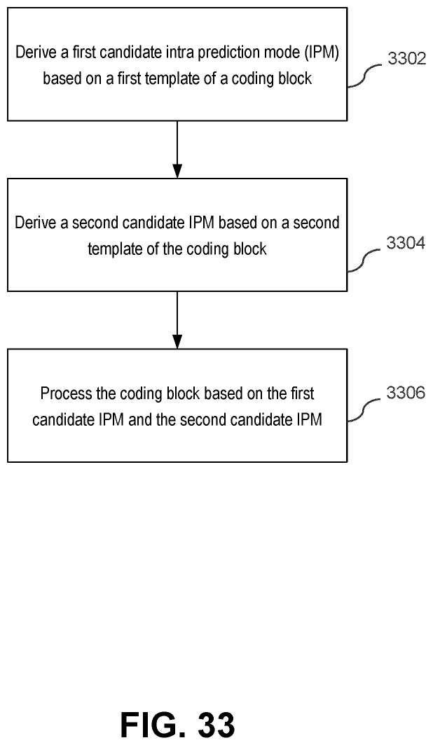

FIG. 32 is an example flowchart of determining a partition candidate list size based on characteristics (e.g., on encoder side).

In examples, at 3202, characteristics may be obtained. The characteristics may be associated with a current block. The characteristics may include one or more of the following: frame resolution, slice type, block size, and/or block shape. In examples, the frame resolution may be 4k. The slice type may be an intra coded slice, such as an I slice. The slice type may be an inter coded slice, such as a B slice. The block size may be associated with a width (w) and a height (h). In examples, the block size may be 8×8.

At 3204, based on one or more of the plurality of characteristics (e.g., frame resolution, slice type, block size, and/or block shape), a partition mode candidate list size may be determined for SGPM associated with the current block. At 3206, a partition mode candidate list may be obtained for the current block based on the determined partition mode candidate list size. At 3208, the current block may be encoded based on the partition mode candidate list.

FIG. 33 is an example flowchart for processing (e.g., encoding and/or decoding) a coding block based on candidate IPMs derived using different templates. At 3302, a first candidate intra prediction mode (IPM) may be derived based on a first template of a coding block. At 3304, a second candidate IPM may be derived based on a second template of the coding block. At 3306, the coding block may be processed (e.g., encoded and/or decoded) based on the first candidate IPM and the second candidate IPM.

Although features and elements are described above in particular combinations, one of ordinary skill in the art will appreciate that each feature or element can be used alone or in any combination with the other features and elements. In addition, the methods described herein can be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software can be used to implement a radio frequency transceiver for use in a WTRU, UE, terminal, base station, RNC, or any host computer.

1-26. (canceled)

27. A method for video decoding, the method comprising:
deriving a first candidate intra prediction mode (IPM) based on a first template of a coding block;
deriving a second candidate IPM based on a second template of the coding block; and
decoding the coding block based on the first candidate IPM and the second candidate IPM.

28. The method of claim 27, wherein the method further comprises:
adding the first candidate IPM and the second candidate IPM to an IPM candidate list associated with the coding block, wherein the coding block is decoded based on the IPM candidate list.

29. The method of claim 27, wherein the method further comprises:
selecting a third candidate IPM based on a partition mode of the coding block; and
adding the first candidate IPM, the second candidate IPM, and the third candidate IPM to an IPM candidate list associated with the coding block, wherein the coding block is decoded based on the IPM candidate list.

30. The method of claim 27, wherein the coding block comprises a first partition and a second partition, and wherein the method further comprises:
generating an IPM candidate list associated with the coding block based on the first candidate IPM and the second candidate IPM; and
determining a first prediction mode for the first partition and a second prediction mode for the second partition based on a spatial geometric partition mode (SGPM) index and the IPM candidate list.

31. The method of claim 27, wherein the method further comprises:
determining that an SGPM is used for the coding block; and
based on determining that the SGPM is used for the coding block, obtaining the first template and the second template of the coding block for IPM derivation, wherein the second template is different from the first template.

32. The method of claim 27, wherein the method further comprises:
determining that an SGPM is used for the coding block;
based on determining that the SGPM is used for the coding block, obtaining the first template and the second template of the coding block for IPM derivation;
obtaining a third template of the coding block that comprises the first and the second template; and
ranking a plurality of candidates in an SGPM candidate list associated with the coding block based on the third template of the coding block.

33. The method of claim 27, wherein the method further comprises:
determining the first template and the second template of the coding block based on a partition mode associated with the coding block.

34. The method of claim 27, wherein the coding block comprises a first partition and a second partition, and wherein the method further comprises:
determining the first template of the coding block based on the first partition;
decoding the first partition of the coding block based at least on the first candidate IPM derived based on the first template;
determining the second template of the coding block based on the second partition; and
decoding the second partition of the coding block based at least on the second candidate IPM derived based on the second template.

35. The method of claim 27, wherein the method further comprises:
obtaining a left template of the coding block as the first template; and
obtaining a top template of the coding block as the second template.

36. The method of claim 27, wherein the method further comprises:
obtaining a left template of the coding block having a width of 1 as the first template; and
obtaining a top template of the coding block having a height of 1 as the second template.

37. A video decoding device comprising:
a processor configured to:
derive a first candidate intra prediction mode (IPM) based on a first template of a coding block;
derive a second candidate IPM based on a second template of the coding block; and
decode the coding block based on the first candidate IPM and the second candidate IPM.

38. The device of claim 37, wherein the processor is configured to:
add the first candidate IPM and the second candidate IPM to an IPM candidate list associated with the coding block, wherein the coding block is decoded based on the IPM candidate list.

39. The device of claim 37, wherein the processor is configured to:
select a third candidate IPM based on a partition mode of the coding block; and
add the first candidate IPM, the second candidate IPM, and the third candidate IPM to an IPM candidate list associated with the coding block, wherein the coding block is decoded based on the IPM candidate list.

40. The device of claim 37, wherein the coding block comprises a first partition and a second partition, and wherein the processor is further configured to:
generate an IPM candidate list associated with the coding block based on the first candidate IPM and the second candidate IPM; and
determine a first prediction mode for the first partition and a second prediction mode for the second partition based on a spatial geometric partition mode (SGPM) index and the IPM candidate list.

41. The device of claim 37, wherein the processor is configured to:
determine that an SGPM is used for the coding block; and
based on the determination that the SGPM is used for the coding block, obtain the first template and the second template of the coding block for IPM derivation, wherein the second template is different from the first template.

42. The device of claim 37, wherein the processor is further configured to:
determine that an SGPM is used for the coding block;
based on the determination that the SGPM is used for the coding block, obtain the first template and the second template of the coding block for IPM derivation;
obtain a third template of the coding block that comprises the first and the second template; and
rank a plurality of candidates in an SGPM candidate list associated with the coding block based on the third template of the coding block.

43. The device of claim 37, wherein the processor is further configured to:
determine the first template and the second templates of the coding block based on a partition mode associated with the coding block.

44. The device of claim 37, wherein the coding block comprises a first partition and a second partition, and wherein the processor is further configured to:
determine the first template of the coding block based on the first partition;
decode the first partition of the coding block based at least on the first candidate IPM derived based on the first template;
determine the second template of the coding block based on the second partition; and
decode the second partition of the coding block based at least on the second candidate IPM derived based on the second template.

45. The device of claim 37, wherein the processor is further configured to:
obtain a left template of the coding block as the first template; and
obtain a top template of the coding block as the second template.

46. The device of claim 37, wherein the processor is further configured to:
obtain a left template of the coding block having a width of 1 as the first template; and
obtain a top template of the coding block having a height of 1 as the second template.
